(19) United States
(12) Patent Application Publication
(10) Pub. No.: US 2011/0013481 A1
(43) Pub. Date: Jan. 20, 2011

(54) METHOD AND APPARATUS FOR DETECTING MARINE DEPOSITS

(76) Inventor: David Alan Clark, Lexington, KY (US)

Correspondence Address: NIXON & VANDERHYE, PC, 901 NORTH GLEBE ROAD, 11TH FLOOR, ARLINGTON, VA, 22203, US

(21) Appl. No.: 12/734,612

(22) PCT Filed: Nov. 12, 2008
(86) PCT No.: PCT/AU2008/001674

§ 371 Date: Sep. 8, 2010

(30) Foreign Application Priority Data
Nov. 12, 2007 (AU) 2007906202

(51) Int. Cl. G01V 1/38

(52) U.S. Cl. 367/15

(57) ABSTRACT

Noise compensation in controlled source electromagnetics (CSEM) comprises measuring time-varying magnetic gradients of the marine environment subjected to CSEM. From the measured magnetic gradients, oceanographic electric and magnetic field noise is determined and used for noise compensation of CSEM measurements of electric and magnetic fields. Selection of magnetic gradient measurement provides improved measurement of oceanographic magnetic noise as other electromagnetic noise sources produce negligible magnetic gradients in the marine environment. Electric field noise is then predicted from the magnetic measurements.

### CROSS-REFERENCE TO RELATED APPLICATIONS

The present application claims priority from Australian Provisional Patent Application No 2007906202 filed on 12 Nov. 2007, the content of which is incorporated herein by reference.

### TECHNICAL FIELD

The present invention relates to oceanographic electromagnetic and magnetotelluric surveys, and in particular to techniques for addressing noise conditions encountered during such surveys.

### BACKGROUND OF THE INVENTION

Controlled-source electromagnetic (CSEM) geophysical methods are a recently developed technology for mapping subsurface resistivity variations in the marine environment, as well as on land. CSEM is being increasingly applied in offshore hydrocarbon exploration. Specific variants of the method include applications known as Seabed Logging (SBL) or Remote Reservoir Resistivity Mapping (R3M). CSEM methods utilize man-made sources (typically 0.1 Hz to 10 kHz), to investigate the variation of electrical conductivity in the Earth, typically in the depth range of hundreds of meters to several kilometres. Data inversion is applied to received signals to gain an understanding of the probed region.

Marine CSEM generally uses a horizontal electrical dipole (HED), which may be a transmitter towed behind a survey vessel, which emits a low frequency (0.1 Hz-10 Hz) electromagnetic (EM) signal into the sea water, which propagates through the underlying seabed and into the subsurface. In the presence of an anomalous sub-seafloor resistor the propagation of the EM field is distorted, which may be considered analogous to seismic refraction. Energy is constantly refracted back to the seafloor and is detected by receivers placed on the sea floor. The detection of the ‘guided and refracted’ energy using electric field sensors, often in combination with magnetic sensors, is the basis of CSEM. Because oil and gas accumulations, for example, do not conduct electricity, they appear as ‘resistive’ geological layers, in contrast to brine-filled reservoirs, which are electrically conductive. Archie's law indicates that the method is more sensitive to high saturation hydrocarbon pore fill and due to the low frequency nature only relatively large accumulations of high saturation will be detectable.

CSEM methods offer a number of advantages compared to natural-source electromagnetic (NSEM) methods such as magnetotellurics (MT). These advantages include relative insensitivity to regional effects and small near-surface inhomogeneities which adversely affect MT, and the ability to utilize different source types and orientations to improve resolution. A particular advantage for marine hydrocarbon exploration is that CSEM is sensitive to thin resistive layers, such as hydrocarbon reservoirs, whereas these layers are almost invisible to MT. However, MT is a useful adjunct to other marine geophysical exploration methods for mapping base of salt bodies, sub-basalt imaging etc. Nevertheless, with such low frequency sources the 3-D interpretation of the CSEM data is complex. Moreover, the ocean wave dynamo and oceanic currents are sources of noise for marine electromagnetic exploration, with waves, swells and ocean currents (among other sources) creating electromagnetic noise that interferes with the signal. Further, while CSEM in deep water benefits from the overlying water filtering out EM noise originating above the water, this is not true at depths less than a few hundred metres and CSEM has to date been less successful in such shallow water.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY OF THE INVENTION

According to a first aspect the present invention provides a method for noise compensation in controlled source electromagnetics (CSEM), the method comprising:
measuring time-varying magnetic gradients of a marine environment subjected to CSEM;
from the measured magnetic gradients, determining oceanographic electric and magnetic field noise; and
compensating CSEM measurements of electric and magnetic fields for noise by using the determined oceanographic electric and magnetic noise.

According to a second aspect the present invention provides a system for noise compensation in controlled source electromagnetics (CSEM), the system comprising:
at least one magnetic gradiometer for measuring magnetic gradients of a marine environment subjected to CSEM;
a data processing means which is arranged to, from the measured magnetic gradients, determine oceanographic electric and magnetic noise, and which is arranged to compensate CSEM measurements for noise by using the determined oceanographic electric and magnetic noise.

According to a third aspect the present invention provides a computer program product comprising computer program code means to make a computer execute a procedure for noise compensation in controlled source electromagnetics (CSEM), the computer program product comprising:
computer program code means for measuring magnetic gradients of a marine environment subjected to CSEM;
computer program code means for determining oceanographic electric and magnetic noise from the measured magnetic gradients; and
computer program code means for compensating CSEM measurements for noise by using the determined oceanographic electric and magnetic noise.

The present invention thus provides for reduction of noise in CSEM data by incorporating a second data set based on magnetic gradiometry. Notably, the present invention provides for the detection of sources of magnetic field noise in order to predict what the electric field noise would be. The present invention is based in part on the recognition that information on wave motions is much more easily obtained from measurements of magnetic fields and their gradients than from measurements of electric fields or their associated conduction currents. Further, the present invention recognises that, because other sources of electromagnetic noise produce negligible magnetic gradients, the measurement of such gradients allows oceanographic magnetic noise in particular to be measured in isolation, and subsequently removed from other measured fields. The predicted electric noise is then subtracted from the CSEM signal or otherwise used to enhance the CSEM signal to noise ratio.

Preferably, the measurements of magnetic gradients comprise measurements of a magnetic gradient tensor or total field gradients. Alternatively, measurements of fluctuations in the horizontal gradient of the total field in the direction of propagation may suffice for determination of the wave-induced magnetic field components, as such fluctuations arise almost entirely from wave motions.

In some embodiments, suppression of wave-induced noise may be effected by design of a filter based on identified gradient fluctuations within a narrow frequency band such as in the range 0.05-0.2 Hz. Alternatively, where well-defined gradient fluctuations are measured, some embodiments may directly calculate corresponding wave-induced magnetic and electric fields and remove them from the measured data.

In some embodiments of the invention the sensor may be housed within the conductive medium by a substantially spherical cavity. In such embodiments, magnetic field may be measured directly, while electric field measurements are preferably amplitude adjusted to allow for the effect that electric field within the cavity is uniform, parallel to the unperturbed applied field and larger by 50%. Such embodiments may further provide for distinguishing magnetic gradients arising from background sources, and determining the local electric current flow within the conductive medium.

Preferably, instrumental sensitivity is improved by stacking and spectral discrimination.

Instrumental sensitivity may further be improved by rotating a magnetometer about an axis, and measuring the field component at a plurality of different orientations during the rotation. Such embodiments preferably provide for precise synchronous detection and accurate angular orientation. By measuring the field component at many different orientations during the rotation, such embodiments provide for many independent estimates of the field to be made, allowing the standard error of the measurement to be substantially reduced. In the frequency domain, this can be regarded as reducing the measurement bandwidth by narrowband detection at the fundamental frequency. Moreover, in such embodiments the key feature of interest is the noise power at the rotation frequency, as the rest of the noise power is distributed among all the frequency components up to the Nyquist frequency of the sampling of successive orientations. In other words, instead of a bandwidth equal to the Nyquist frequency associated with the sampling rate of a static sensor, the measurement bandwidth becomes the frequency resolution of the Fourier transform of the time series, which is 1/T, where T is the total spin time per reading.

For magnetometers having a non-white noise spectrum in the oceanographic frequency range of interest, spinning the magnetometer can potentially overcome this problem by shifting the effective measurement frequency to a white noise region, as well as allowing substantial signal stacking. Where the magnetometer is a fluxgate, rotation through 180° enables the offset to be determined, yielding the absolute value of the field component, and continuously performing this process eliminates all long term drift of the offset, which is the time domain equivalent of the 1/f noise.

### BRIEF DESCRIPTION OF THE DRAWINGS

An example of the invention will now be described with reference to the accompanying drawings, in which:

FIG. 1 illustrates a general-purpose computing device that may be used in an exemplary system for implementing the invention;

FIG. 2 plots the relationship between period T and wavelength λ for gravity waves in a moderately (1 km) deep ocean;

FIG. 3 is a plot of phase speed and period versus wavelength for gravity waves in a 1 km deep ocean;

FIG. 4 plots the relationship between T and λ for gravity waves in a very shallow (20 m) ocean;

FIG. 5 shows how the phase and group speeds increase with wavelength for gravity waves in 20 m deep water;

FIG. 6 is a plot of amplitudes of TMI fluctuations at the ocean surface;

FIG. 7 plots amplitudes of magnetic gradient fluctuations at the ocean surface;

FIG. 8 plots amplitudes of TMI fluctuations 50 m above the ocean surface, for wavelengths up to 350 m;

FIG. 9 plots amplitudes of TMI fluctuations 50 m above the ocean surface, per unit wave height;

FIG. 10 plots amplitude of magnetic field fluctuations, per unit wave height, as a function of wavelength for varying altitude, while FIG. 11 is the same plot using a logarithmic scale for wavelength to clarify the behaviour at shorter wavelengths;

FIG. 12 plots amplitudes of gradient tensor fluctuations 50 m above the ocean surface, for wavelengths up to 200 m

FIG. 13 is as for FIG. 12, but for wavelengths up to 5600 m;

FIG. 14 plots amplitude of magnetic gradient tensor fluctuations, for maximum wave height, as a function of wavelength for varying altitudes;

FIG. 15 is as for FIG. 14, but with a log scale for wavelength to clarify the behaviour at shorter wavelengths; and

FIGS. 16a to 16d are plots of velocity, electric current, magnetic field and magnetic field gradient, respectively, versus depth, for the case where v₀=2 ms⁻¹ and z₀=1100 m, in a 4 km deep (σ=3.2 Sm⁻¹) ocean with a 1 km thick conductive (σ′=1 Sm⁻¹)seafloor.

### DESCRIPTION OF THE PREFERRED EMBODIMENTS

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

Turning to the drawings, wherein like reference numerals refer to like elements, the invention is illustrated as being implemented in a suitable computing environment. Although not required, the invention will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor-based or programmable consumer electronics, network PCs, minicomputers, mainframe computers, and the like. The invention may be practiced in distributed computing environments where tasks are performed by remote processing devices that are linked through a communications network. In a distributed computing environment, program modules may be located in both local and remote memory storage devices.

The following description begins with a description of a general-purpose computing device that may be used in an exemplary system for implementing the invention, and the invention will be described in greater detail with reference to subsequent Figures.

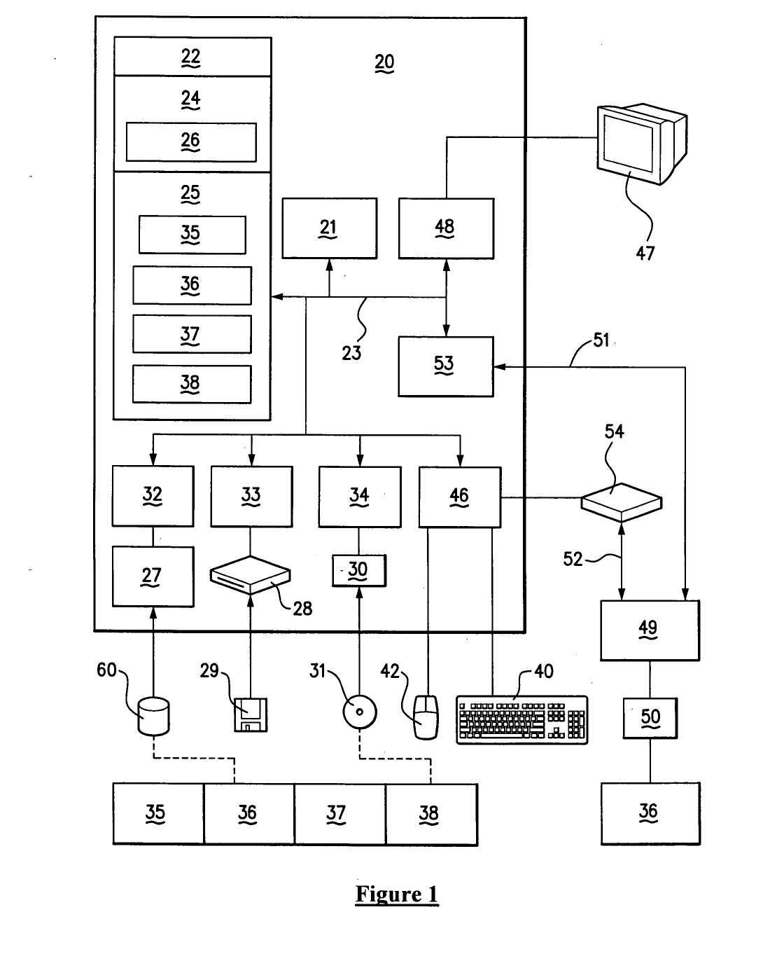

Turning now to FIG. 1, a general purpose computing device is shown in the form of a conventional personal computer 20, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help to transfer information between elements within the personal computer 20, such as during start-up, is stored in ROM 24. The personal computer 20 further includes a hard disk drive 27 for reading from and writing to a hard disk 60, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer readable instructions, data structures, program modules and other data for the personal computer 20. Although the exemplary environment described herein employs a hard disk 60, a removable magnetic disk 29, and a removable optical disk 31, it will be appreciated by those skilled in the art that other types of computer readable media which can store data that is accessible by a computer, such as magnetic cassettes, flash memory cards, digital video disks, Bernoulli cartridges, random access memories, read only memories, storage area networks, and the like may also be used in the exemplary operating environment.

A number of program modules may be stored on the hard disk 60, magnetic disk 29, optical disk 31, ROM 24 or RAM 25, including an operating system 35, one or more applications programs 36, other program modules 37, and program data 38. A user may enter commands and information into the personal computer 20 through input devices such as a keyboard 40 and a pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port or a universal serial bus (USB) or a network interface card. A monitor 47 or other type of display device is also connected to the system bus 23 via an interface, such as a video adapter 48. In addition to the monitor, personal computers typically include other peripheral output devices, not shown, such as speakers and printers.

The personal computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the personal computer 20, although only a memory storage device 50 has been illustrated in FIG. 1. The logical connections depicted in FIG. 1 include a local area network (LAN) 51 and a wide area network (WAN) 52. Such networking environments are commonplace in offices, enterprise-wide computer networks, intranets and, inter alia, the Internet. When used in a LAN networking environment, the personal computer 20 is connected to the local network 51 through a network interface or adapter 53. When used in a WAN networking environment, the personal computer 20 typically includes a modem 54 or other means for establishing communications over the WAN 52. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used.

In the description that follows, the invention will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that various of the acts and operations described hereinafter may also be implemented in hardware.

NOTATION

| | |
|---|---|
| g | acceleration due to gravity (9.8 ms_{^{−2}}) |
| D | depth of ocean (m) |
| λ | wavelength of water waves (m) |
| T | period of wave motion (s) |
| f | frequency of wave motion (Hz) |
| ω, ω′ | angular frequency of wave motion (rad/s) [wrt static, |
| | moving sensors] |
| k | wavenumber of water waves (m_{^{−1}}) |
| k | wavevector of water waves (parallel to direction of |
| | propagation) |
| C | phase speed of water waves (ms_{^{−1}}) |
| C^{_{g}} | group speed of water waves (ms_{^{−1}}) |
| a | amplitude of water waves (m) |
| a^{ₘₐₓ} | maximum amplitude of wind-produced water waves (m) |
| (x, y, z) | co-ordinates wrt right-handed Cartesian axes (x parallel to |
| | wave propagation, z vertically down). Corresponding unit |
| | vectors are \hat{x}, ŷ, z |
| F | geomagnetic field vector [substantially uniform and |
| | time-invariant over area] |
| F | geomagnetic field intensity (T) |
| X | x component of F (T) |
| Z | vertical down component of F (T) |
| θ | direction of wave propagation (°E of magnetic north) |
| B | total magnetic flux density (T) [B = F + b] |
| b | magnetic flux density due to induced currents (T) |
| B^{₀} | vector amplitude of time harmonic flux density (T) |
| E | electric field with respect to stationary reference frame (Vm_{^{−1}}) |
| E^{₀} | vector amplitude of time harmonic electric field (Vm_{^{−1}}) |
| D | electric displacement (Cm_{^{−2}}) |
| P | electric polarisation (Cm_{^{−2}}) |
| V | electrostatic potential (V) |
| A | magnetic vector potential (Tm) |
| ρ | free charge density (Cm_{^{−3}}) |
| j | electric current density (Am_{^{−2}}) |
| μ^{₀} | permeability of free space (4π × 10_{^{−7}} TmA_{^{−1}}) |
| ε^{₀} | permittivity of free space (8.86 × 10_{^{−12}} CV_{^{−1}}m_{^{−1}}) |
| ε = ε^{ᵣ}ε^{₀} | permittivity (CV_{^{−1}}m_{^{−1}}) |
| ε^{ᵣ} | relative permittivity [=81 for typical sea water] |
| σ | conductivity (Sm_{^{−1}}) [~4 Sm_{^{−1}}for typical sea water] |
| v | velocity of sea water (ms_{^{−1}}) |
| φ | velocity potential of sea water (m_{²}s_{^{−1}}) |
| u | velocity of mobile sensor (ms_{^{−1}}) |
| ψ | angle between directions of sensor motion and wave propagation |
| d | depth of sensor (m) |
| h | altitude of sensor (m) |
| β | dimensionless constant, β = μ^{₀}σω/k_{²} |
| ζ | surface charge density (Cm_{^{−2}}) |

### Overview

The ocean wave dynamo produces harmonically-varying induced electric currents and electromagnetic fields. For example, surface waves in deep water with wavelengths ˜70 m, period ˜7 s, phase speed ˜10 ms⁻¹ and wave height ˜1.5 m produce magnetic field fluctuations near the surface with an amplitude of ˜1 nT and magnetic gradients of ˜90 pT/m.

The corresponding amplitude of the electric field fluctuations is ˜10 nVm⁻¹, which is about the same as the sensitivity of marine electrometers and is therefore difficult to measure. Electric fields from oceanic, ionospheric and mantle sources are at least two orders of magnitude stronger than electric fields due to wave motions. For example, the Lorentz field (v×F) due to a steady flow of 1 ms⁻¹ in a favourably oriented geomagnetic field of 50 μT is 50 Nm⁻¹. Even though the frequencies and spatial scales of the wave-induced electric field are quite distinct from the low frequency, large scale fields due to other sources, the present invention is based in part on the recognition that information on wave motions is much more easily obtained from measurements of magnetic fields and their gradients than from measurements of electric fields or their associated conduction currents.

Below the surface the vertical and horizontal components of the wave-induced magnetic field are given by (J. T. Weaver, J. Geophys. Res., 70 (1965), 1921-1929):

$${b}_{z} = \frac{a {μ}_{0} σω F ( icosθcos I + sin I )}{4 k} ( 2 kz + 1 ) exp ( iω t - i kx - kz ) , \\ {b}_{x} = \frac{i a {μ}_{0} σω F ( icosθcos I + sin I )}{4 k} ( 2 kz - 1 ) exp ( iω t - i kx - kz ) ,$$

where z is the distance beneath the surface, a is the wave amplitude, ω is the angular frequency, k is the wavenumber, the geomagnetic field intensity and inclination are F and I, respectively, θ is the direction of wave propagation (° E of magnetic north), and σ is the sea water conductivity. These equations indicate that the magnetic field is circularly polarised at the surface, becomes increasingly elliptically polarised with depth, with a vertical major axis, until it is vertically linearly polarised at a depth d=½k=λ/4π. Below this depth it is elliptically polarised, in the opposite sense of rotation to the shallow field. The ratio of the amplitudes of the harmonic electric and magnetic fields, both above and below the surface, is simply the phase speed of the surface waves C=ω/k. The electric field is in phase with the vertical component of the magnetic field.

The magnetic field fluctuations are proportional to wave height, for a given wavelength. However the dependence on wavelength is just as important, with longer waves producing stronger signals. Coupled with the slower fall-off with height for longer wavelengths, long ocean swells are considerably more important than even large amplitude, short waves (high seas). Beneath the sea surface the expressions are more complicated, and the fall-off rate is initially slower, but eventually a quasi-exponential decay of signal also occurs.

Expressions for fluctuations of the total field and its gradients, and magnetic gradient tensor elements can be calculated from the formulae for the magnetic field components, set out in the following. The results show that short wavelength seas (λ<10 m) are only detectable very near the surface, but 100 m wavelength swells can be detected by magnetometers with sensitivity of 0.01 nT and/or magnetic gradiometers with sensitivity of 1 pT/m at an altitude of 50 m and a depth of 100 m. Long wavelength swells (with wavelengths greater than 500 m, periods longer than 18 s) are detectable at least 200 m above the surface and to at least 1000 m below the surface. The required instrumental sensitivities should be readily achievable on the sea floor, because the nature of the signal enables considerable stacking and spectral discrimination.

The present invention is further based in part on the recognition that the presence of electric current distributions within a conductive medium changes the structure of the magnetic gradient tensor fundamentally. In air or free space the gradient tensor is both traceless and symmetric. On the other hand, in the presence of conduction currents the curl of B is non-zero and the gradient tensor is asymmetric. This raises the question of what is actually measured by magnetometers and gradiometers immersed in the electrically conductive ocean, and in particular, how the signal measured within a sealed measurement capsule relates to the field components and tensor elements that existed in the surrounding medium prior to insertion of the measurement capsule.

It will be shown in the following that the effect of a spherical cavity within an initially uniform horizontal electric current distribution is:
The electric field within the cavity is uniform, parallel to the unperturbed applied field and larger by 50%.
The magnetic field at the centre of the cavity is equal to the unperturbed magnetic field that existed at the same point in the conductive medium, prior to insertion of the measurement capsule.
The symmetric magnetic gradient tensor within the cavity is uniform. The only non-zero components are b_{yz}=b_{zy}. These components are each equal to half the value of B_{yz} that is produced by the unperturbed current flow. The current density in the medium, prior to insertion of the measurement capsule, is given by jₓ=−2b_{yz}/μ₀.

This provides a way of determining the local electric current flow within the sea water, provided magnetic gradients arising from other sources can be distinguished.

The simplest configuration of sensors for correction of CSEM measurements for wave-induced noise uses distributed sensors with an essentially unperturbed flow of electric current through the sea water separating the sensors, rather than a complete gradiometer within an enclosed capsule. This idealised situation is approximated, for example, by an array of sensors on long thin arms protruding from a small capsule that contains a power supply and data acquisition system, or by gradiometers consisting of sensors mounted at the ends of a thin rod. Magnetic gradients are obtained by subtraction of magnetic field measurements at different sensors, without any need for geometric corrections.

The ocean wave dynamo and oceanic currents are sources of noise for marine electromagnetic exploration. Measurements of magnetic gradients can potentially allow electric and magnetic field noise of oceanographic origin to be calculated and removed from the measured fields, thereby improving signal-to-noise ratios and facilitating marine exploration for hydrocarbons, including gas hydrates, and metal sulphides.

Measurement of the magnetic gradient tensor or total field gradients can contribute to suppression of electromagnetic noise due to wave motions in two ways. Firstly, identification of gradient fluctuations above the instrumental noise level within a relatively narrow frequency band in the range 0.05-0.2 Hz can facilitate the design of filters designed to suppress wave-induced noise, over the same range of frequencies, from the measured electric and magnetic fields. Secondly, well-defined gradient fluctuations can be used to directly calculate the corresponding wave-induced magnetic and electric fields and remove them from the measured data.

The vertical and horizontal magnetic field fluctuations due to wave motions within a frequency band centred on frequency f may be calculated from the Fourier transformed time series of the measured horizontal gradient of the total field, using:

$${b}_{z} ( f ) = \frac{i g ( icosθcos I + sin I ) ( \frac{8 {π}^{2} {f}^{2} z}{g} + 1 ) \frac{\partial {b}_{T}}{\partial x} ( f )}{\begin{matrix}4 {π}^{2} {f}^{2} ( {cos}^{2} {θcos}^{2} I + {sin}^{2} I ) ( 1 - \frac{8 {π}^{2} {f}^{2} z}{g} ) + \\ \frac{64 {π}^{4} {f}^{4} z}{g} sin I ( sin I + i cos θcos I )\end{matrix}} , \\ {b}_{x} ( f ) = \frac{- g ( icosθcos I + sin I ) ( \frac{8 {π}^{2} {f}^{2} z}{g} - 1 ) \frac{\partial {b}_{T}}{\partial x} ( f )}{\begin{matrix}4 {π}^{2} {f}^{2} ( {cos}^{2} {θcos}^{2} I + {sin}^{2} I ) ( 1 - \frac{8 {π}^{2} {f}^{2} z}{g} ) + \\ \frac{64 {π}^{4} {f}^{4} z}{g} sin I ( sin I + i cos θcos I )\end{matrix}} ,$$

where the maximum horizontal gradient fluctuations parallel the x-axis, which is parallel to the direction of wave propagation. Wave-induced electric fields parallel to the wave crests may be simply calculated from the vertical magnetic field component, using the relationship E_{y}=Cb_{z}=(g/2πf)b_{z}. This allows correction of seafloor electrometer data for wave noise, if the electric field effects are significant.

While the preceding gives an overview of aspects of the present embodiment of the invention, these aspects are set out more fully in the following.

### Properties of Surface Waves

For surface waves with wavelengths greater than ˜10 cm the dominant restoring force is gravity. These waves are dispersive, except in very shallow water, where the depth is less than one twentieth of the wavelength. For such long gravity waves the period is proportional to the wavelength and the phase speed is independent of wavelength. For the general case, however, in an ocean of depth D the phase speed or celerity of surface gravity waves, C, is given by:

$$C = {[ \frac{g λ}{2 π} tanh ( \frac{2 π D}{λ} ) ]}^{\frac{1}{2}} , \qquad ( 1 )$$

where g is the acceleration due to gravity and λ is the wavelength.

For long gravity waves, (1) reduces to:

C=\sqrt{gD}(λ>20D), (2)

and for short gravity waves in the deep ocean, (1) becomes:

$$C = \sqrt{\frac{g λ}{2 π}} ( λ < 2 D ) . \qquad ( 3 )$$

For dispersive waves, where C=C(λ), the group speed (speed of the wave front) differs from the speed C of the individual crests within the wave package. From (1) and fundamental theory of wave motions, the general relationships between λ, C, period T, frequency f, angular frequency w, wavenumber k and group speed C_{g} are:

$$\begin{matrix}T = \frac{λ}{C} = {[ \frac{2 π λ}{g} coth ( \frac{2 π D}{λ} ) ]}^{\frac{1}{2}} & ( 4 ) \\ f = \frac{1}{T} = {[ \frac{g}{2 πλ} tanh ( \frac{2 π D}{λ} ) ]}^{\frac{1}{2}} & ( 5 ) \\ ω = 2 π f = {[ \frac{2 π g}{λ} tanh ( \frac{2 π D}{λ} ) ]}^{\frac{1}{2}} & ( 6 ) \\ k = \frac{2 π}{λ} = \frac{ω}{C} & ( 7 ) \\ C = \frac{ω}{k} & ( 8 ) \\ {C}_{g} = \frac{d ω}{d k} = C - λ \frac{d C}{d λ} = \frac{C}{2} + \frac{gD}{2 C} {sech}^{2} ( \frac{2 π D}{λ} ) & ( 9 )\end{matrix}$$

Equation (9) can be rewritten in a form that is more suitable for numerical evaluation for extreme values of D/λ:

$${C}_{g} = \frac{C}{2} + \frac{gD}{2 C} [ 1 - {tanh}^{2} ( \frac{2 π D}{λ} ) ] . \qquad ( 10 )$$

In deep water the absolute maximum wave height is limited by spontaneous breaking, which occurs when the height is one seventh of the wavelength. However, a more realistic maximum amplitude corresponds to the saturation state produced by wind of a given speed, acting for an unlimited duration and fetch. The corresponding wind waves have wavelengths and heights that are both proportional to the square of the wind speed. For example a wind of 5 m/s produces waves of height up to 0.5 m, with a wavelength of 16 m, whereas a wind speed of 25 m/s produces waves up to 12.5 m high, with a wavelength of 400 m. The maximum wave height, 2Aₘₐₓ, of wind waves is therefore simply related to the wavelength:

Aₘₐₓ=λ/64 (deep water). (11)

The fully developed wind waves propagate away from the source region as swell. Over large travel distances the short wavelength waves are highly attenuated, so the swell is increasingly dominated by long wavelengths. Long swells are independent of the local sea state and may have considerable amplitude even when local wind-generated seas are slight. Long waves produce stronger magnetic effects, for a given wave height, so the magnetic effects of distantly generated swells often dominate the wind wave-generated magnetic signal.

In shallow water, on the other hand, breaking occurs when the depth is ˜1.3 times the wave height, i.e.

Aₘₐₓ=D/1.3 (shallow water). (12)

For short gravity waves in deep water, the general relationships between λ and the other parameters of the wave motion simplify to:

$$\begin{matrix}T = \frac{λ}{C} = \sqrt{\frac{2 π λ}{g}} ( λ < 2 D ) & ( 13 ) \\ f = \frac{1}{T} = \sqrt{\frac{g}{2 πλ}} ( λ < 2 D ) & ( 14 ) \\ ω = 2 π f = \sqrt{\frac{2 π g}{λ}} ( λ < 2 D ) & ( 15 ) \\ {C}_{g} = \frac{1}{2} \sqrt{\frac{g λ}{2 π}} = \frac{C}{2} ( λ < 2 D ) . & ( 16 )\end{matrix}$$

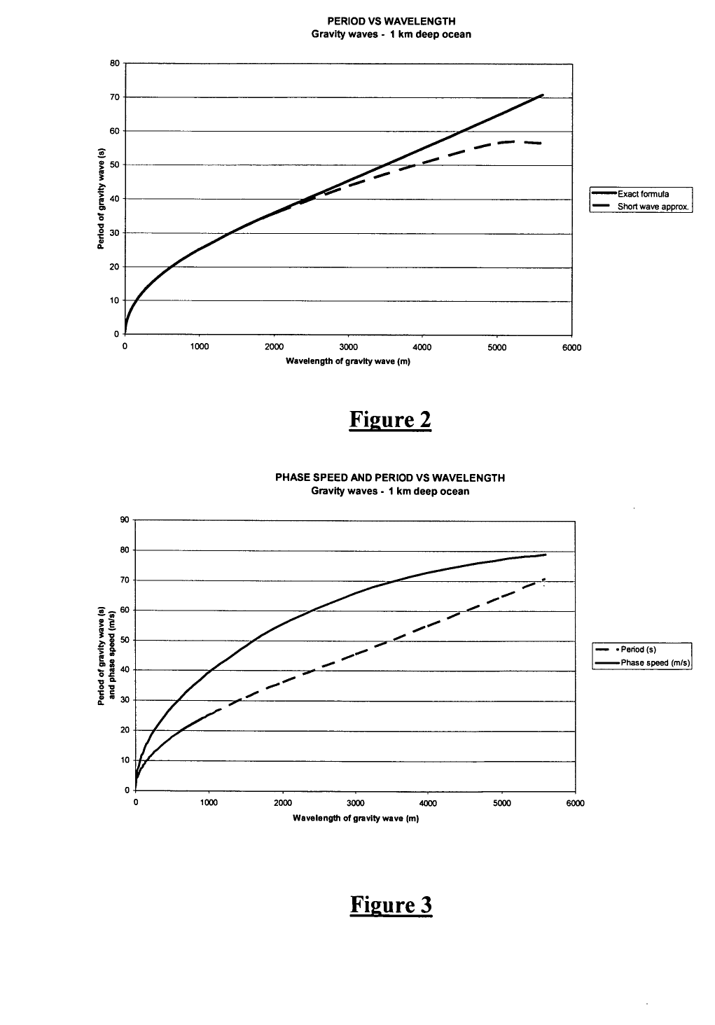

FIG. 2 plots the relationship between period T and wavelength λ for gravity waves in a moderately (1 km) deep ocean, showing the comparison between the exact formula and the short wave approximation. Note the accuracy of the short wave approximation until the wavelength exceeds about 2.5 times the ocean depth. FIG. 3 is a plot of phase speed and period versus wavelength for gravity waves in a 1 km deep ocean, calculated using the exact relationships (1) and (4), and shows how the phase speed increases with wavelength for this water depth.

For long gravity waves the corresponding relations are:

$$\begin{matrix}T = \frac{λ}{C} = \frac{λ}{\sqrt{gD}} ( λ > 20 D ) & ( 17 ) \\ f = \frac{1}{T} = \frac{\sqrt{gD}}{λ} ( λ > 20 D ) & ( 18 ) \\ ω = 2 π f = \frac{2 π \sqrt{gD}}{λ} ( λ > 20 D ) & ( 19 ) \\ {C}_{g} = \sqrt{gD} = C ( λ > 20 D ) . & ( 20 )\end{matrix}$$

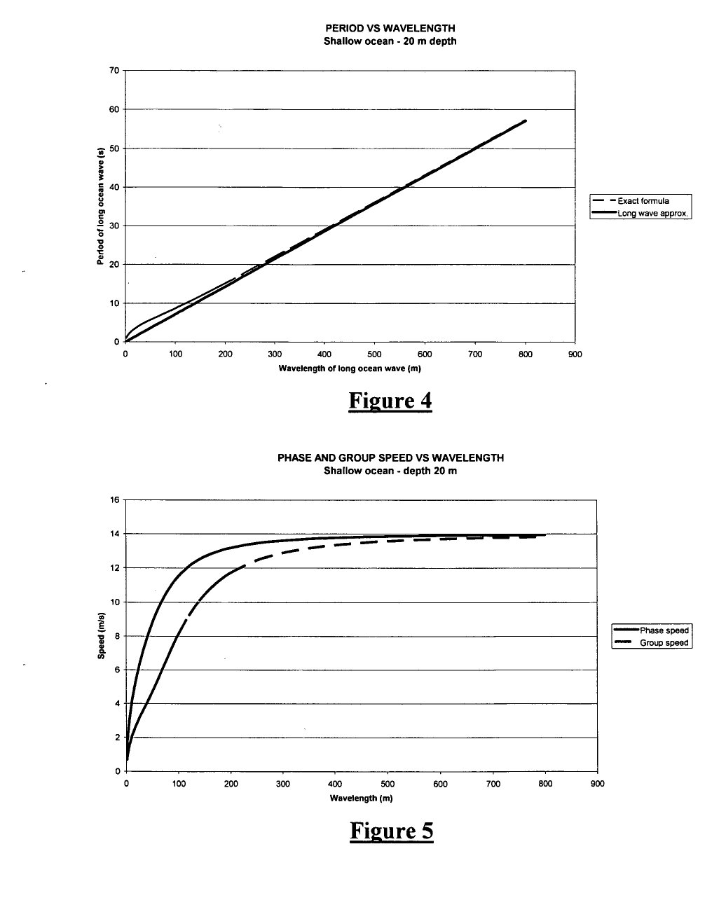

FIG. 4 plots the relationship between T and λ for gravity waves in a very shallow (20 m) ocean, showing the comparison between the exact formula and the long wave approximation. FIG. 5 shows how the phase and group speeds increase with wavelength for gravity waves in 20 m deep water, calculated using the exact relationships (1) and (10). Note that dispersion becomes negligible and the group and phase speeds converge for very long waves, asymptotically approaching ˜14 ms⁻¹.

### Electromagnetic Fields in the Ocean

Because sea water is electrically conductive, motions of the sea in the geomagnetic field induce electric currents, which generate secondary magnetic fields. Ocean currents generate slowly varying electric and magnetic fields in response to changes in flow velocity or structure. An ocean swell acts as a dynamo that produces alternating magnetic fields above and within the ocean.

The starting point for calculation of the electromagnetic fields in the ocean is Maxwell's equations for a moving medium, with velocity v:

$$\begin{matrix}∇ \cdot D = ρ , & ( 21 ) \\ ∇ \cdot B = 0 , & ( 22 ) \\ ∇ \times E = - \frac{\partial B}{\partial t} , & ( 23 ) \\ ∇ \times B = {μ}_{0} ( j + ρ v + \frac{\partial D}{\partial t} + ∇ \times P \times v ) , & ( 24 )\end{matrix}$$

with the constitutive equations:

D=∈₀E+P, (25)

P=∈₀(∈ᵣ−1)(E+v×B), (26)

j=σ(E+v×B). (27)

Note that E is the electric field in a stationary frame of reference and v×B is the Lorentz field arising from the motion. B is the vector sum of the geomagnetic field F, which is taken to be uniform over the area of interest, and the magnetic flux density b arising from induced currents in the ocean and sea floor. The very weak magnetisations of the sea and the atmosphere are neglected.

Although the complete magnetohydrodynamic relations for sea water are complicated, many simplifications can be made. In particular, displacement currents can be neglected, induced magnetic fields are always small compared to the geomagnetic field, and the Lorentz body force acting on the moving sea water is negligible compared to pressure and buoyancy forces. Because the secondary field from induced currents is much smaller than the geomagnetic field, we can replace B by F in (26) and (27):

P=∈₀(∈ᵣ−1)(E+v×B), (28)

j=σ(E+v×F). (29)

For ocean waves the displacement current term is negligible compared to the conduction current, even at the highest wave motion frequencies:

$$ɛ \frac{\partial E}{\partial t} \sim {ɛ}_{r} {ɛ}_{0} ω E \approx 4.5 \times {10}^{- 9} E << {μ}_{0} σ E \approx 5 \times {10}^{- 6} E ,$$

where we have used ∈ᵣ=81 and σ=4 Sm⁻¹ for sea water and taken f=1 Hz. At the dominant frequencies of surface and internal waves, which are typically ˜0.1 Hz and ˜0.001 Hz respectively, the displacement current term is even smaller relative to the conduction current. The first, conduction current, term on the RHS of (24) is larger than the other three terms by a factor of at least 10⁹ for large scale oceanic flows. Even for rapidly moving surface waves, the velocity-dependent terms are at least six orders of magnitude smaller than the conduction current term. Accordingly, equation (24) simplifies to

∇×b=μ₀j, (30)

to a very good approximation.

Equation (23) states that b is solenoidal. It can therefore be expressed as the curl of a vector potential A. Because the addition of the gradient of an arbitrary scalar field does not change its curl, A is not unique until its divergence is specified. Using the simplest choice, the Coulomb gauge, which stipulates that A is solenoidal, we have:

∇×A=b, (31)

∇·A=0. (32)

Using the identity ∇×∇×A=∇(∇·A)−∇²A, it follows from (30)-(32) that:

∇²A=−μ₀j, (33)

i.e. A obeys Poisson's equation in regions where the current density is non-zero, and Laplace's equation in regions without conduction currents.

Substituting (31) into (23) gives:

$$∇ \times ( E + \frac{\partial A}{\partial t} ) = 0 \\ ∴ E + \frac{\partial A}{\partial t} = - ∇ V , for some scalar field V .$$

Therefore, when the fields are time-varying, the electric field is given by:

$$E = - ∇ V - \frac{\partial A}{\partial t} , \qquad ( 34 )$$

where V is the electrostatic potential.

### Electromagnetic Fields Due to the Ocean Wave Dynamo

The treatment below extends the analysis to provide expressions for the magnetic gradient tensor components, total field gradients, electric field and current density. F is essentially uniform at the scale of ocean wave motions and is also taken to be constant in time for analysis of wave motions. We want to calculate the time-varying field b=b(x,y,z,t), which arises from local induced currents, and its spatial gradients.

To solve for E and b, v must be specified. Since sea water is incompressible:

∇·v=0. (35)

Assuming that the flow is also irrotational (∇×v=0), it follows that:

v=∇φ, (36)

where, by (35), φ obeys Laplace's equation:

∇²φ=0. (37)

Any surface wave motion in the ocean can be considered as the superposition of simple harmonic components. Since the equations relating E, B and v are linear their solutions for an arbitrary wave motion are simply the linear superposition of the solutions for simple harmonic wave motions. Simple harmonic solutions of (37) that represent progressive waves, with amplitudes much smaller than their wavelength, take the form:

φ=(aω/k)exp(iωt−ikx−kz), (38)

where i=√(−1) and the phase speed is ω/k along the x axis. The corresponding velocity field is:

v=∇φ=−aω[i\hat{x}+\hat{z}]exp(iωt−ikx−kz) (39)

and the maximum displacement at the surface (z≈0), obtained by integrating (39) with respect to time, is a. Equation (39) implies that the motion of the water particles is circularly polarised. Below the surface, the velocity field attenuates exponentially with depth z, with water motions decreasing by a factor of e≈2.718 over each depth interval of 1/k=λ/2π.

Since v is harmonic in t and x, the electrical and magnetic fields arising from v are also harmonic in these variables. Accordingly, we can write:

E=E₀(z)exp(iωt−ikx), (40)

b=b₀(z)exp(iωt−ikx). (41)

From (40) and (41) it follows that differentiation of the fields with respect to time is equivalent to multiplication by iω and differentiation with respect to x reduces to multiplication by −ik.

Given the 2D nature of the problem, with water motions confined to the vertical plane that contains the direction of propagation, the magnetic fields are also confined to this plane, and the associated electric field and induced currents are parallel to the wave crests (along±ŷ), this electromagnetic field being called the transverse electric type.

Using ∇·b=0, we get from (41):

$$\frac{\partial {b}_{z}}{\partial z} = i {kb}_{x} . \qquad ( 42 )$$

Taking the curl of (30), substituting for j from (29) and simplifying gives:

∇×∇×b=∇(∇·b)−∇²b=−∇²b=μ₀∇×j=μ₀σ∇×(E+v×F).

Noting that F is a constant vector, so that ∇×(v×F)=(F·∇)v, and substituting for ∇×E from (23) gives:

$$\begin{matrix}{∇}^{2} b = {μ}_{0} σ [ \frac{\partial b}{\partial t} - ( F \cdot ∇ ) v ] \\ = {μ}_{0} σ [ \frac{\partial b}{\partial t} + kF ( i cos θcos I + sin I ) v ]\end{matrix}$$

$$\begin{matrix}∴ {∇}^{2} b = \frac{{\partial }^{2} b}{\partial {x}^{2}} + \frac{{\partial }^{2} b}{\partial {z}^{2}} \\ = - {k}^{2} b + \frac{{\partial }^{2} b}{\partial {z}^{2}} \\ = {μ}_{0} σ [ iω b + kF ( i cos θcos I + sin I ) v ] .\end{matrix}$$

Substituting for v from (39), cancelling the harmonic terms and rearranging gives:

$$\frac{{\partial }^{2} {b}_{0}}{\partial {z}^{2}} = [ {k}^{2} + {iμ}_{0} σω ] {b}_{0} - a {μ}_{0} σω kF ( icosθcos I + sin I ) ( i \hat{x} + \hat{z} ) exp ( - kz ) . \qquad ( 43 )$$

In the air above the surface σ=0, so (43) reduces to:

$$\frac{{\partial }^{2} {b}_{0}}{\partial {z}^{2}} = {k}^{2} {b}_{0} ( z < 0 ) . \qquad ( 44 )$$

We require solutions of (43) and (44) that go to zero at great distances from the surface (z→±∝). In the subsurface (z>0), the vertical component of equation (43) is satisfied by:

(b₀)_{z}=Qexp(−z\sqrt{k²+iμ₀σω})−iakF(i cos θ cos I+sin I)exp(−kz) (z>0), (45)

where Q is an arbitrary constant. Above the surface (z<0), the corresponding solution that is regular at infinity is:

(b₀)_{z}=Rexp[kz] (z<0), (46)

where R is any constant.

The constants Q and R can be determined from the boundary conditions at the air-sea interface. Since we are assuming that the wave amplitude is much smaller than the wavelength, this interface can be simply taken as the plane z=0. The normal component of b is continuous across this boundary (as b is solenoidal everywhere). The tangential component is also continuous, since the magnetisation is zero everywhere. Therefore the vertical derivative of the vertical component, which by (42) is proportional to the x component, is also continuous across the ocean surface. Applying these boundary conditions gives:

$$\begin{matrix}Q = \frac{2 i {ak}^{2} F ( i cos θcos I + sin I )}{k + \sqrt{{k}^{2} + {iμ}_{0} σω}} , & ( 47 ) \\ R = \frac{- akF ( icosθcos I + sin I )}{{μ}_{0} σω} {( k - \sqrt{{k}^{2} + {iμ}_{0} σω} )}^{2} . & ( 48 )\end{matrix}$$

Substituting (47) into (45) we get for the spatial dependence of the vertical component of the field below the surface:

$${( {b}_{0} )}_{z} = i akF ( icosθcos I + sin I ) [ \frac{2}{1 + \sqrt{1 + iβ}} exp ( - kz \sqrt{1 + iβ} ) - exp ( - kz ) ] ( z > 0 ) , \qquad ( 49 )$$

where the dimensionless parameter β is defined by:

β=μ₀σω/k². (50)

The horizontal component is then obtained by applying (42) to (49):

$${( {b}_{0} )}_{x} = - akF ( i cos θcos I + sin I ) [ \frac{2 \sqrt{1 + iβ}}{1 + \sqrt{1 + iβ}} exp ( - kz \sqrt{1 + iβ} ) - exp ( - kz ) ] ( z > 0 ) . \qquad ( 51 )$$

The magnetic field is in general elliptically polarised below the surface. The corresponding results above the surface are:

$$\begin{matrix}{( {b}_{0} )}_{z} = \frac{- akF ( icosθcos I + sin I )}{β} {( 1 - \sqrt{1 + iβ} )}^{2} exp ( kz ) ( z < 0 ) , \\ and & ( 52 ) \\ {( {b}_{0} )}_{x} = \frac{i akF ( icosθcos I + sin I )}{β} {( 1 - \sqrt{1 + iβ} )}^{2} exp ( kz ) ( z < 0 ) , & ( 53 )\end{matrix}$$

which show that the field above the surface is circularly polarised and attenuates exponentially with altitude. The fall-off rate is proportional to k=2π/λ, i.e. it is slower for long wavelengths.

It has been shown that β<1 for all common situations and that β<<1 for all but the longest period swells. Expressions (49), (51)-(53) can therefore be simplified by expanding the (1+iβ)^{1/2} term as 1+iβ/2+O(β²) and neglecting terms of second and higher order. The time variations and spatial structure of the fields are then given by:

$$\begin{matrix}{b}_{z} = \frac{a {μ}_{0} σω F ( icosθcos I + sin I )}{4 k} ( 2 kz + 1 ) exp ( iω t - i kx - kz ) ( z > 0 ) , & ( 54 ) \\ {b}_{x} = \frac{i a {μ}_{0} σω F ( icosθcos I + sin I )}{4 k} ( 2 kz - 1 ) exp ( iω t - i kx - kz ) ( z > 0 ) , & ( 55 )\end{matrix}$$

where we have used expression (50) for β. Equations (54) and (55) indicate that the magnetic field is circularly polarised at the surface, becomes increasingly elliptically polarised with depth, with a vertical major axis, until it is vertically linearly polarised at a depth d=½k=λ/4π. Below this depth it is elliptically polarised, in the opposite sense of rotation to the shallow field.

The corresponding results above the surface are:

$$\begin{matrix}{b}_{z} = \frac{a {μ}_{0} σω F ( icosθcos I + sin I )}{4 k} exp ( iω t - i kx + kz ) ( z < 0 ) , & ( 56 ) \\ {b}_{x} = \frac{- i a {μ}_{0} σω F ( icosθcos I + sin I )}{4 k} exp ( iω t - i kx + kz ) ( z < 0 ) . & ( 57 )\end{matrix}$$

Apart from the amplitude, the simple harmonic wave motions are completely defined by a single parameter, e.g. wavelength or frequency. In terms of wavelength, equations (54)-(57) become:

$$For z > 0$$

$$\begin{matrix}{b}_{z} = a {μ}_{0} σ F ( θ ) \sqrt{\frac{g λ}{32 π}} ( \frac{4 π z}{λ} + 1 ) exp ( i \sqrt{\frac{2 π g}{λ}} t - i2π x / λ - 2 π z / λ ) , & ( 58 ) \\ {b}_{x} = - i a {μ}_{0} σ F ( θ ) \sqrt{\frac{g λ}{32 π}} ( \frac{4 π z}{λ} - 1 ) exp ( i \sqrt{\frac{2 π g}{λ}} t - i2π x / λ - 2 π z / λ ) . \\ For z < 0 \text{:} & ( 59 ) \\ {b}_{z} = a {μ}_{0} σ F ( θ ) \sqrt{\frac{g λ}{32 π}} exp ( i \sqrt{\frac{2 π g}{λ}} t - i2π x / λ + 2 π z / λ ) , & ( 60 ) \\ {b}_{x} = - i a {μ}_{0} σ F ( θ ) \sqrt{\frac{g λ}{32 π}} exp ( i \sqrt{\frac{2 π g}{λ}} t - i2π x / λ + 2 π z / λ ) . \\ where F ( θ ) = F ( icosθcos I + sin I ) . & ( 61 )\end{matrix}$$

The equivalent formulae, in terms of frequency, are:

$$For z > 0$$

$$\begin{matrix}{b}_{z} = \frac{a {μ}_{0} σ gF ( θ )}{8 π f} ( \frac{8 {π}^{2} {f}^{2} z}{g} + 1 ) exp ( \begin{matrix}i2π ft - {i4π}^{2} {f}^{2} x / g - \\ 4 {π}^{2} {f}^{2} z / g\end{matrix} ) , & ( 62 ) \\ {b}_{x} = \frac{- a {μ}_{0} σ gF ( θ )}{8 π f} ( \frac{8 {π}^{2} {f}^{2} z}{g} - 1 ) exp ( \begin{matrix}i2π ft - {i4π}^{2} {f}^{2} x / g - \\ 4 {π}^{2} {f}^{2} z / g\end{matrix} ) . \\ For z < 0 \text{:} & ( 63 ) \\ {b}_{z} = \frac{a {μ}_{0} σ gF ( θ )}{8 π f} exp ( \begin{matrix}i2π ft - {i4π}^{2} {f}^{2} x / g + \\ 4 {π}^{2} {f}^{2} z / g\end{matrix} ) , & ( 64 ) \\ {b}_{x} = \frac{- a {μ}_{0} σ gF ( θ )}{8 π f} exp ( \begin{matrix}i2π ft - {i4π}^{2} {f}^{2} x / g + \\ 4 {π}^{2} {f}^{2} z / g\end{matrix} ) . & ( 65 )\end{matrix}$$

Because |b|<<F, the corresponding total field components are, to a very good approximation, simply the projection of b onto the regional geomagnetic field direction:

b_{T}=b·F/F=bₓ cos θ cos I+b_{z} sin I. (66)

The total field variations at depth z>0 within the ocean are obtained by substituting equations (54)-(55) into (66):

$${b}_{T} = \frac{a {μ}_{0} σω F}{4 k} [ \begin{matrix}( {cos}^{2} {θcos}^{2} I + {sin}^{2} I ) ( 1 - 2 kz ) + \\ 4 kz sin I ( sin I + icos θcos I )\end{matrix} ] \times exp ( iω t - i kx - kz ) . \qquad ( 67 )$$

The amplitude of the total field variations is then:

$$\vert {b}_{T} \vert = \frac{a {μ}_{0} σω F}{4 k} \sqrt{( {cos}^{2} {θcos}^{2} I + {sin}^{2} I ) [ \begin{matrix}{cos}^{2} {θcos}^{2} {I ( 1 - 2 kz )}^{2} + \\ {sin}^{2} {I ( 1 + 2 kz )}^{2}\end{matrix} ]} {e}^{- kz} \qquad ( 68 )$$

At altitude h above the surface the corresponding expression for the TMI variations is:

$${b}_{T} = \frac{a {μ}_{0} σω F}{4 k} [ ( {cos}^{2} {θcos}^{2} I + {sin}^{2} I ) ] exp ( {iω}^{′} t - i kz - kh ) , \qquad ( 69 )$$

where ω′ is the apparent angular frequency of the waves as observed from a sensor travelling at velocity u at an angle ψ to the direction of wave propagation:

ω′=ω(1−ku cos ψ). (70)

The corresponding amplitude of the total field variations is:

$$\vert {b}_{T} \vert = \frac{a {μ}_{0} σω F}{4 k} ( {cos}^{2} {θcos}^{2} I + {sin}^{2} I ) exp ( - kh ) . \qquad ( 71 )$$

Observations of total field magnetic fluctuations associated with ocean swells give very satisfactory agreement with the expressions above. Note that for east-west propagating waves (θ=90°) at the geomagnetic equator (I=0°), all field components vanish.

Equations (68) and (71) relate to the amplitudes of the total field variations due to ocean waves. We are interested in the variations in the gradient tensor elements and gradients of the total field, as well as the vector and total field components.

Below the surface the gradient tensor elements can be obtained by differentiating equations (49) and (51) with respect to x and z. The gradient tensor elements obtained in this way are:

$$\begin{matrix}{b}_{xx} = - i {kb}_{x} , & ( 72 ) \\ {b}_{xy} = {b}_{yx} = {b}_{yz} = {b}_{zy} = 0 , & ( 73 ) \\ {b}_{xz} = - i {kb}_{z} + \frac{2 i a {μ}_{0} σω F}{1 + \sqrt{1 + i β}} ( i cos θcos I + sin I ) {e}^{iω t - i kx - kz \sqrt{1 + iβ}} , & ( 74 ) \\ {b}_{zx} = - i {kb}_{z} , & ( 75 ) \\ {b}_{zz} = i {kb}_{x} . & ( 76 )\end{matrix}$$

Note that the tensor is traceless, but it is not symmetric within the ocean. This is due to the induced current density, which produces a magnetic field with non-zero curl. Equations (74) and (75) allow this induced current density to be calculated from (30):

$$j = \frac{2 i a σω F}{1 + \sqrt{1 + i β}} ( i cos θcos I + sin I ) \hat{y} {e}^{iω t - i kx - kz \sqrt{1 + iβ}} . \qquad ( 77 )$$

Writing (1+iβ)^{1/2}=1+β/2+O(β²) and neglecting terms of second and higher order, (74) becomes:

$${b}_{xz} = - i {kb}_{z} + i a {μ}_{0} σω F ( i cos θcos I + sin I ) [ 1 - \frac{iβ ( 1 + 2 kz )}{4} ] {e}^{iω t - i kx - kz} , \qquad ( 78 )$$

and the induced current is, to the same order of approximation:

$$j = i a σω F ( icos θcos I + sin I ) [ 1 - \frac{i β ( 1 + 2 kz )}{4} ] \hat{y} {e}^{iω t - i kx - kz} . \qquad ( 79 )$$

Above the surface the gradient tensor is both symmetric and traceless. Its elements are:

bₓₓ=−ikbₓ, (80)

b_{xy}=b_{yx}=b_{yz}=b_{zy}=0, (81)

b_{xz}=b_{zx}=−ikb_{z}, (82)

b_{zz}=ikbₓ. (83)

Total field gradients can be calculated from the gradient tensor elements according to:

$$\begin{matrix}\frac{\partial {b}_{T}}{\partial x} = ( cos θcos I ) {b}_{xx} + ( sin I ) {b}_{zx} & ( 84 ) \\ \frac{\partial {b}_{T}}{\partial z} = ( cos θ cos I ) {b}_{xz} + ( sin I ) {b}_{zz} & ( 85 )\end{matrix}$$

The induced electric field can be calculated similarly to the magnetic field. Substituting (40) and (41) into (23) gives:

∇×E=−iωb.

Taking the curl of both sides, using ∇×∇×E=∇(∇·E)−∇²E, and noting that (21) and (25)-(27) give ∇·E=∇·[D/∈+j(∈−∈₀)/σ)]=ρ/∈−(∈−∈₀)/σ)(∂ρ/σt)=0 we get:

∇²E=iω∇×b.

We have used the fact that free charges are absent within the ocean. An electrostatic type field can arise from free charges that halt vertical electric currents at the surface, but the wave motions considered here produce horizontal electric currents that parallel the wave crests, i.e. E=E_{y}^{ŷ}, and therefore produce no surface charges.

Using (30) it follows that:

∇²E(z)=iμ₀ωj(z) (z>0), (86)

and

∇²E(z)=0 (z<0). (87)

Substituting for j from (29) and equating y components gives:

∇²E_{y}=iμ₀σω[E_{y}+(v×F)_{y})] (z>0).

From (39), (v×F)_{y}=−aωF(cos θ cos I−i sin I)exp[iωt−ikx−kz], and since differentiation of E with respect to x is equivalent to multiplication by −ik, we get after rearranging and cancelling the harmonic dependences:

$$\frac{{\partial }^{2} {E}_{y}}{\partial {z}^{2}} = [ {k}^{2} + {iμ}_{0} σω ] {E}_{y} - i a {μ}_{0} {σω}^{2} F ( i cos θcos I + sin I ) exp ( - kz ) ( z > 0 ) . \qquad ( 88 )$$

Above the surface E_{y} obeys:

$$\frac{{\partial }^{2} {E}_{y}}{\partial {z}^{2}} = {k}^{2} {E}_{y} ( z < 0 ) . \qquad ( 89 )$$

Solutions of (88) that go to zero when z→∞ take the form:

E_{y}=Qexp(−z\sqrt{k²+μ₀σω})−aμ₀σω²F(i cos θ cos I+sin I)exp(−kz) (z>0), (90)

where Q is an arbitrary constant. Above the surface (z<0), the corresponding solution that vanishes as z→−∞ is:

E_{y}=Rexp[kz] (z<0), (91)

where R is any constant.

As for the magnetic field, the constants Q and R can be determined from the boundary conditions at the air-sea interface, which is taken to be the plane z=0. The horizontal component of E is continuous across this boundary. This follows from the fact that ∇×E=−iωb, so the circulation of E around a rectangular loop straddling the surface is equal to the rate of change of magnetic flux through the loop (by Stokes' theorem), which becomes vanishingly small as the limbs of the loop approach the surface from above and below. The vertical derivative of E_{y} is also continuous at the surface, since it is proportional to bₓ, which is continuous. Applying these boundary conditions gives:

$$\begin{matrix}Q = \frac{2 i a ω F ( i cos θcos I + sin I )}{1 + \sqrt{1 + i β}} , & ( 92 ) \\ R = \frac{- a ω F ( icos θcos I + sin I )}{β} {( 1 - \sqrt{1 + i β} )}^{2} . & ( 93 )\end{matrix}$$

Substituting (92) into (90) we get for the spatial dependence of the vertical component of the electric field below the surface:

$${E}_{y} = i a ω F ( i cos θcos I + sin I ) [ \frac{2}{1 + \sqrt{1 + iβ}} exp ( - kz \sqrt{1 + iβ} ) - exp ( - kz ) ] ( z > 0 ) . \qquad ( 94 )$$

Using (93) and (91), the corresponding result above the surface is:

$${E}_{y} = \frac{- a ω F ( icos θcos I + sin I )}{β} {( 1 - \sqrt{1 + iβ} )}^{2} exp ( kz ) ( z < 0 ) , \qquad ( 95 )$$

which shows that the electric field above the surface attenuates exponentially with altitude, with the same fall-off rate as the magnetic field.

From (50)-(51), (52)-(53) and (95) it follows that the ratio of the amplitudes of the harmonic electric and magnetic fields, both above and below the surface, is simply the phase speed of the surface waves:

$$\frac{\vert {E}_{y} \vert}{\vert {b}_{z} \vert} = \frac{ω}{k} = C ( ∀ z ) . \qquad ( 96 )$$

The electric field is in phase with the vertical component of the magnetic field. Equation (96) allows an estimate of the strength of the electric field oscillations from the ocean wave dynamo. Surface waves in deep water with wavelengths ˜70 m, period ˜7 s, phase speed ˜10 ms⁻¹ and wave height ˜1.5 m produce magnetic field fluctuations near the surface with an amplitude of ˜1 nT. The corresponding amplitude of the electric field fluctuations is therefore ˜10 nVm⁻¹, which is about the sensitivity of marine electrometers and is therefore difficult to measure.

For comparison, electric field signals of ˜30 μVm⁻¹ associated with an ocean eddy have been observed, electric field fluctuations recorded as a 56 day time series on the seafloor have typical amplitudes of ˜10 μVm⁻¹, and long period (>4 day) electric field variations due to oceanic flows are ˜1 μVm⁻¹. Relatively short period (˜1 hour) electric field fluctuations, which are associated with the interaction of ionospheric magnetic variations with the ocean and sea floor and are used for magnetotelluric sounding, have amplitudes of ˜10 μVm⁻¹. The Lorentz field (v×F) due to a relatively rapid steady flow of 1 ms⁻¹ in a favourably oriented geomagnetic field of 50 μT is 50 μVm⁻¹.

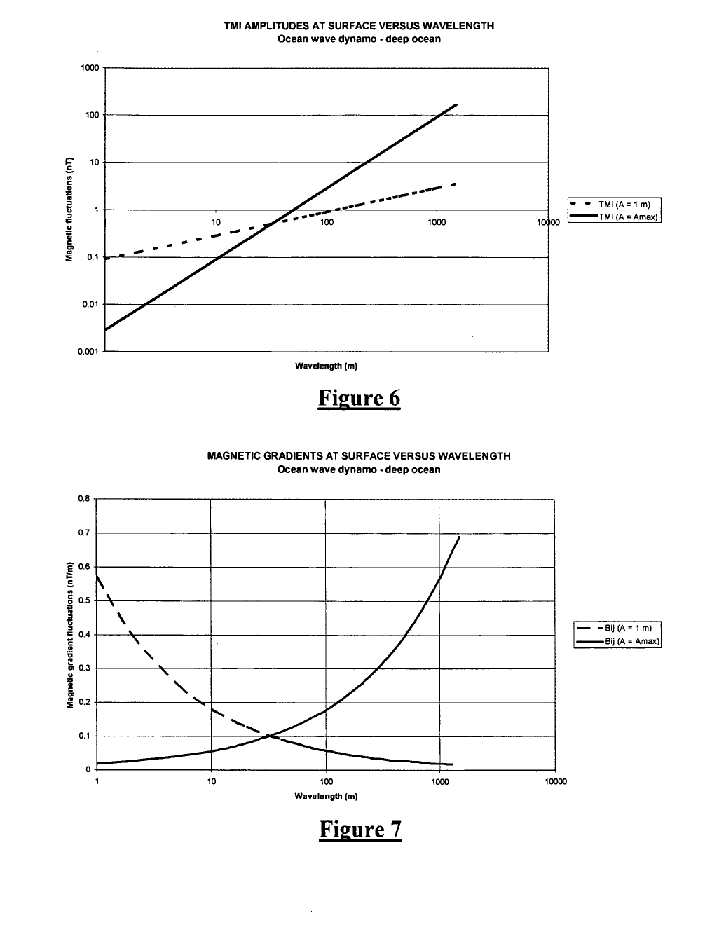

FIG. 6 is a plot of amplitudes of TMI fluctuations at the ocean surface, calculated using (71). The dashed line gives the TMI amplitude per unit wave height, whereas the solid line shows the amplitude for maximum wave height. For wavelengths less than ˜30 m the maximum wave amplitude is less than 1 m, so the TMI fluctuations fall on or below the solid line.

FIG. 7 plots amplitudes of magnetic gradient fluctuations at the ocean surface, calculated using (71) and (80)-(83). The dashed line gives the gradient amplitude per unit wave height, whereas the solid line shows the amplitude for maximum wave height. For wavelengths less than ˜30 m the maximum wave amplitude is less than 1 m, so the gradient fluctuations fall on or below the solid line.

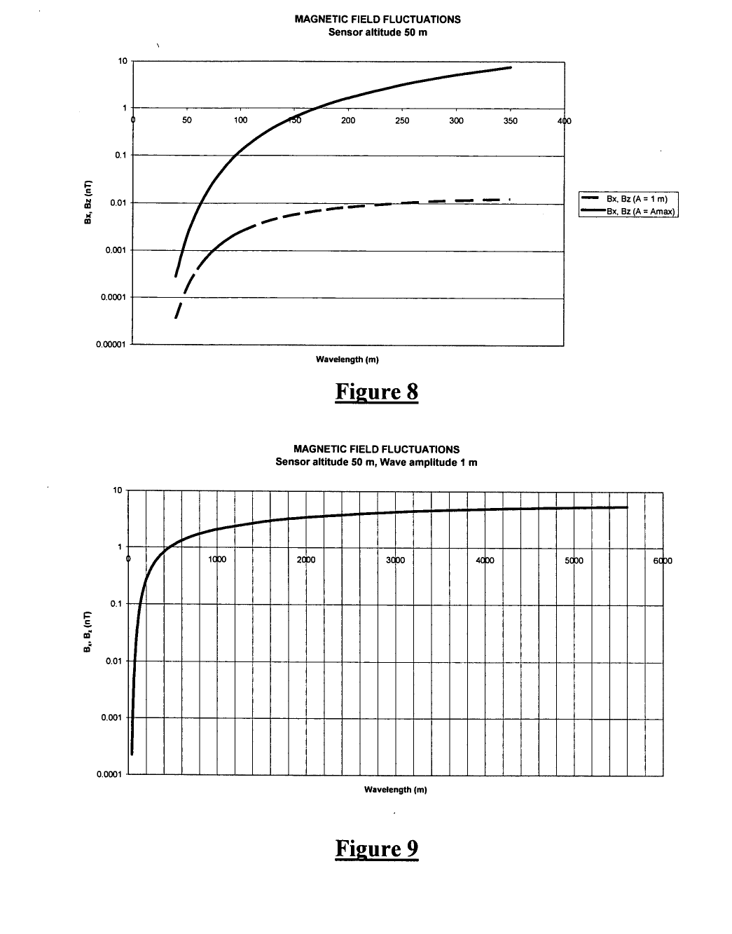

FIG. 8 plots amplitudes of TMI fluctuations 50 m above the ocean surface, for wavelengths up to 350 m, calculated using (71). The dashed line gives the TMI amplitude per unit wave height, whereas the solid line shows the amplitude for maximum wave height.

FIG. 9 plots amplitudes of TMI fluctuations 50 m above the ocean surface, per unit wave height, calculated using (71).

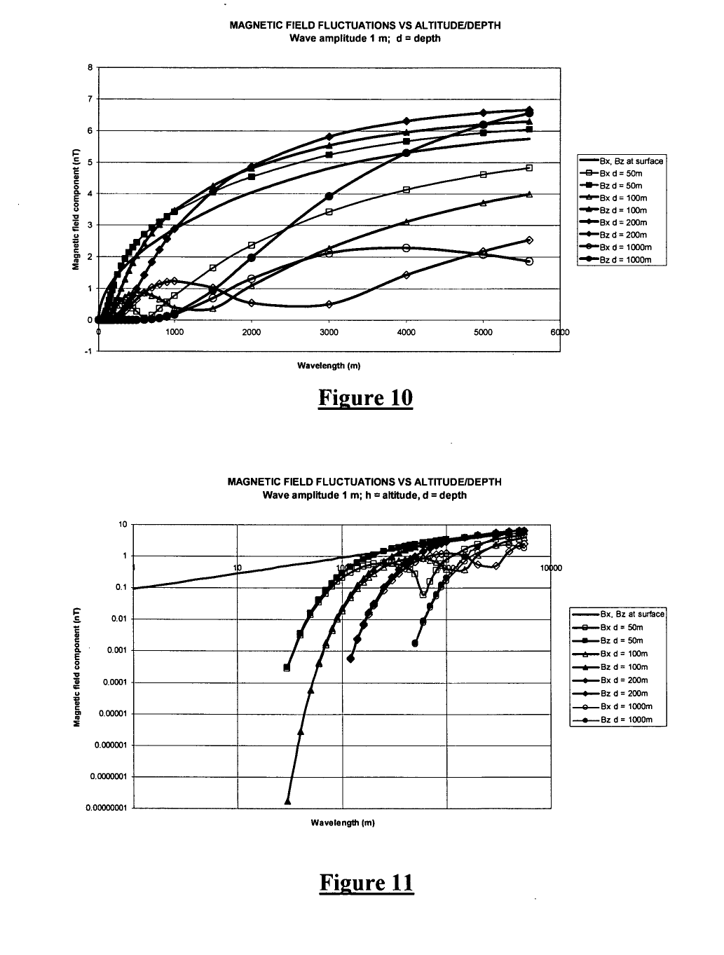

FIG. 10 plots amplitude of magnetic field fluctuations, per unit wave height, as a function of wavelength for altitudes of 50 m, 100 m, 200 m, and depths of 50 m, 100 m, 200 m, and 1000 m.

FIG. 11 is as for FIG. 10, but with a log scale for wavelength to clarify the behaviour at shorter wavelengths.

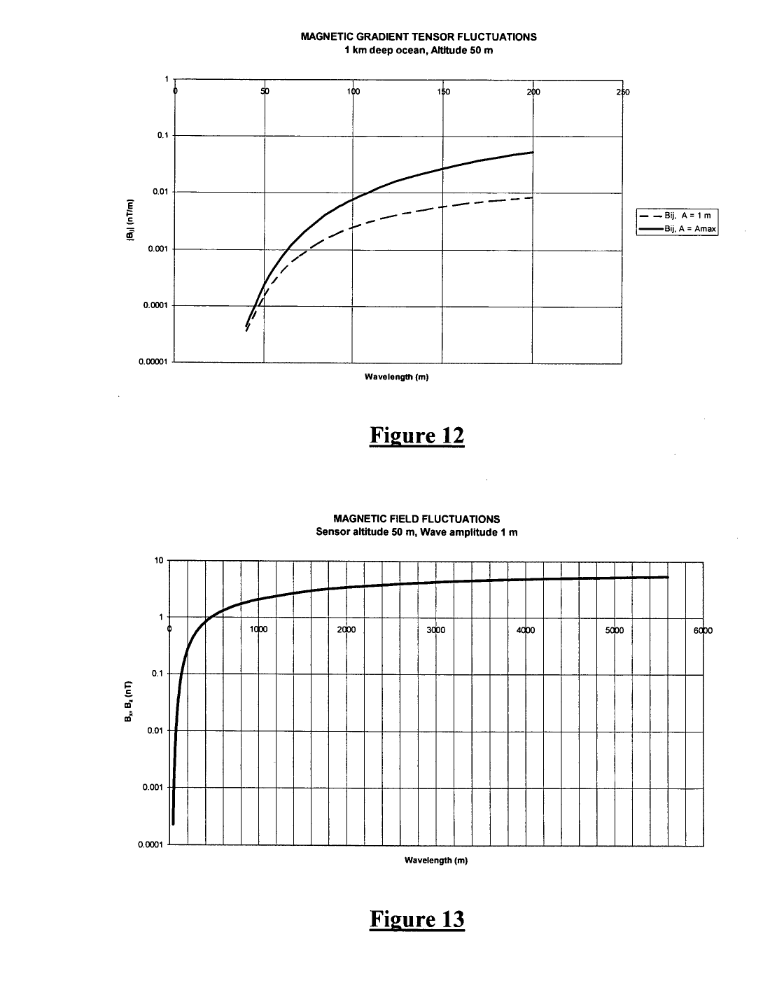

FIG. 12 plots amplitudes of gradient tensor fluctuations 50 m above the ocean surface, for wavelengths up to 200 m, calculated using (71) and (80)-(83). The dashed line gives the gradient amplitude per unit wave height, whereas the solid line shows the amplitude for maximum wave height.

FIG. 13 is as for FIG. 12, but for wavelengths up to 5600 m.

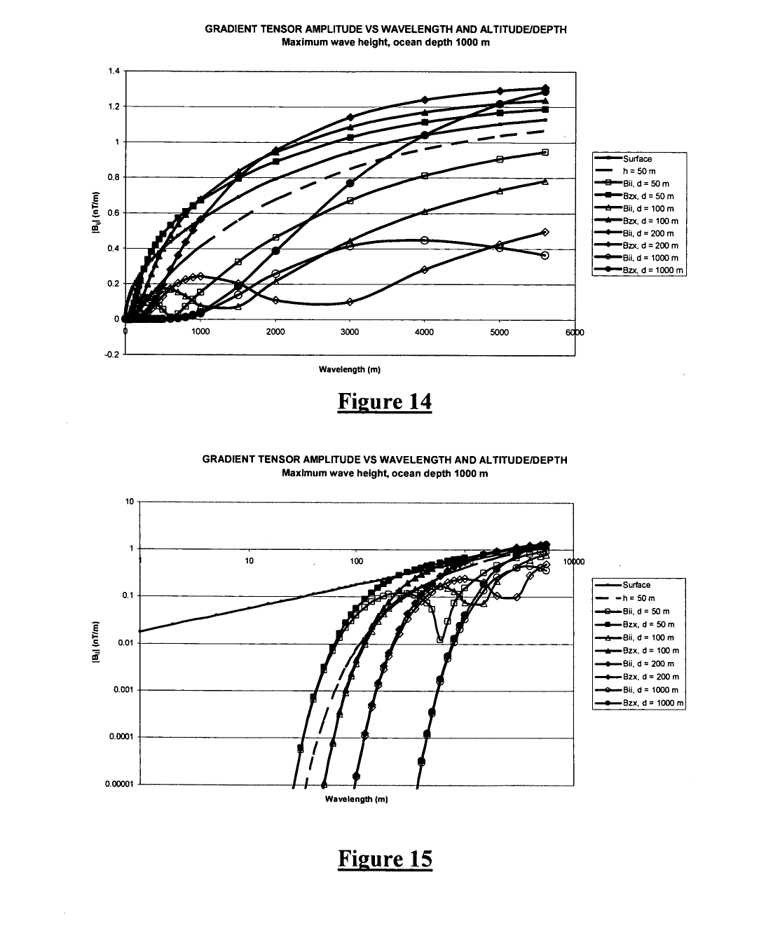

FIG. 14 plots amplitude of magnetic gradient tensor fluctuations, for maximum wave height, as a function of wavelength for altitudes of 50 m, 100 m, 200 m, and depths of 50 m, 100 m, 200 m, and 1000 m.

FIG. 15 is as for FIG. 14, but with a log scale for wavelength to clarify the behaviour at shorter wavelengths.

Thus electric fields from oceanic, ionospheric and mantle sources are at least two orders of magnitude stronger than electric fields due to wave motions. Even though the frequencies and spatial scales of the wave-induced electric field are quite distinct from the low frequency, large scale fields due to other sources, it is nevertheless clear that information on wave motions is much more easily obtained from measurements of magnetic fields and their gradients than from measurements of electric fields or their associated conduction currents.

FIGS. 6-15 show the amplitudes of magnetic field and gradient fluctuations as a function of wavelength at the surface and at altitudes of 50, 100 and 200 m, and depths of 50 m, 100 m, 200 m and 1000 m. The plots show that short wavelength seas (λ<10 m) are only detectable very near the surface, but 100 m wavelength swells can be detected by magnetometers with sensitivity of 0.01 nT and/or magnetic gradiometers with sensitivity of 1 pT/m at an altitude of 50 m and a depth of 100 m. Long wavelength swells (with wavelengths greater than 500 m, periods longer than 18 s) are detectable 200 m above the surface and to at least 1000 m below the surface. The required instrumental sensitivities should be readily achievable on the sea floor, because the nature of the signal enables considerable stacking and spectral discrimination.

### Effects of Oceanic Currents

For the poloidal magnetic (PM) mode the electric currents flow in horizontal planes that couple by induction and there is no vertical electric field. This is the mode that normally dominates the oceanic electromagnetic field. By contrast, the toroidal magnetic (TM) mode involves electric currents that have vertical components, but has no vertical magnetic field component. Thus according to the principles of vertical continuation, the vertical magnetic field, and hence all magnetic field components and gradients, vanish above the ocean surface for TM modes.

We will consider only the very simple situation of a flat-bottomed ocean with horizontal water flows in one direction (taken to be the y axis) that are a function of depth z only. Note that this type of flow is not irrotational, because the curl of v is non-zero wherever the velocity field is varying with depth. This is an example of a PM mode. The electric field is along the x axis and is uniform throughout the water column and the uppermost seafloor. Using (29) we then have:

E=Eₓ\hat{x}

v=v_{y}ŷ

∴jₓ=σ(Eₓ+v_{y}F_{z}).

The electric field arises from the motion-induced current flow, which produces an accumulation of electric charge at great lateral distances (e.g. at coastlines or interfaces with contrasting water flows). This field produces a return electric current, which completes the electric circuit and balances the motion-induced current, at depths where the flow is slower (usually at greater depth). Thus the vertical integral of the electric current density over the complete conductive section is zero. If the seafloor is non-conductive, so the return current is confined to the water column, this means:

$$\begin{matrix}0 = {\int }_{0}^{D} σ [ {E}_{x} + {v}_{y} ( z ) {F}_{z} ] d z \\ ∴ {F}_{z} {\int }_{0}^{D} {v}_{y} ( z ) d z = - {E}_{x} D .\end{matrix}$$

$$\begin{matrix}Thus \\ {\overline{v}}_{y} = - \frac{{E}_{x}}{{F}_{z}} , & ( 97 ) \\ where \\ {\overline{v}}_{y} = \frac{1}{D} {\int }_{0}^{D} {v}_{y} ( z ) d z , & ( 98 )\end{matrix}$$

is the depth-averaged or barotropic water velocity. Equation (97) provides a method of determining this average flow by measuring the horizontal electric field anywhere in the watercolumn, or on the seafloor.

If the seafloor has non-negligible conductivity σ′ over a depth interval of D′, the return current includes the seafloor leakage current. We then have:

$$\begin{matrix}0 = {\int }_{0}^{D} σ [ {E}_{x} + {v}_{y} ( z ) {F}_{z} ] d z + {\int }_{D}^{D + {D}^{′}} {σ}^{′} {E}_{x} d z \\ ∴ σ {F}_{z} {\int }_{0}^{D} {v}_{y} ( z ) d z = - {E}_{x} ( {D}^{′} {σ}^{′} + D σ ) .\end{matrix} \\ Thus \\ {\overline{v}}_{y} = - \frac{{E}_{x}}{{F}_{z}} ( 1 + \frac{{D}^{′} {σ}^{′}}{D σ} ) . \qquad ( 99 )$$

In (99) the term in parentheses represents a correction of (98) for the effects of sea floor leakage. It can be determined, at least in principle, by seafloor measurements of the magnetic field produced by the induced currents. Given the sheet-like geometry of the electric currents, this field simply reflects the difference between the nett electric current flows above and below the sensor, i.e.

$${b}_{y} ( z ) = - \frac{{μ}_{0}}{2} [ {\int }_{0}^{z} {j}_{x} ( ϛ ) d ϛ - {\int }_{z}^{D + {D}^{′}} {j}_{x} ( ϛ ) d ϛ ] . \qquad ( 100 )$$

Above the sea surface, and below the conductive zone of the seafloor, this field vanishes, because the nett current flow within the ocean and seafloor is zero. Thus the seafloor magnetic field is zero if there is no sea floor leakage current. If σ′ is not negligible, however, the seafloor magnetic field can be calculated using (100), noting that jₓ=σ′Eₓ in the seafloor and that the nett current below the seafloor is equal and opposite to the nett current in the overlying water column:

b_{y}=μ₀D′σ′Eₓ, (z=D). (101)

Thus the seafloor conductance is given by:

$${D}^{′} {σ}^{′} = - \frac{{b}_{y}}{{μ}_{0} {E}_{x}} , ( z = D ) . \qquad ( 102 )$$

Equation (102) can be used to estimate the leakage correction factor in (99). Thus in principle the barotropic flow can be determined from seafloor measurements of electric and magnetic fields:

$${\overline{v}}_{y} = \frac{1}{{F}_{z}} ( - {E}_{x} + \frac{{b}_{y}}{{μ}_{0} σ D} ) , ( z = D ) . \qquad ( 103 )$$

The gradients of the magnetic field due to the induced current density can be calculated from (30). Due to the simple structure of the water flow and the induced electric currents, all terms of the magnetic gradient tensor vanish except b_{yz}, which is given by:

b_{yz}=−μ₀jₓ(z). (104)

As an example, consider an ocean current confined to the upper portion of the ocean, with speed v₀=v₀^{ŷ} at the surface, decreasing linearly to zero at depth z₀. Then:

$$\begin{matrix}{v}_{y} = \{ \begin{matrix}{v}_{0} ( 1 - \frac{z}{{z}_{0}} ) , & ( z < {z}_{0} ) \\ 0 , & ( z \geq {z}_{0} )\end{matrix} & ( 105 ) \\ {\overline{v}}_{y} = \frac{{v}_{0} {z}_{0}}{2 D} , & ( 106 ) \\ {E}_{x} = \frac{- σ {F}_{z} {v}_{0} {z}_{0}}{2 ( σ D + {σ}^{′} {D}^{′} )} , ∀ z & ( 107 ) \\ {j}_{x} ( z ) = \{ \begin{matrix}σ [ {E}_{x} + {v}_{0} {F}_{z} ( 1 - \frac{z}{{z}_{0}} ) ] , & ( z \leq {z}_{0} ) \\ σ {E}_{x} , & ( {z}_{0} < z \leq D ) \\ {σ}^{′} {E}_{x} , & ( D < z \leq D + {D}^{′} )\end{matrix} & ( 108 ) \\ {b}_{y} ( z ) = \{ \begin{matrix}- {μ}_{0} σ z [ {E}_{x} + {v}_{0} {F}_{z} ( 1 - \frac{z}{2 {z}_{0}} ) ] & \\ = - {μ}_{0} z [ {j}_{x} ( z ) + \frac{σ {v}_{0} {F}_{z} z}{2} ] , & ( z \leq {z}_{0} ) \\ - {μ}_{0} σ [ {E}_{x} z + \frac{{v}_{0} {F}_{z} {z}_{0}}{2} ] , & ( {z}_{0} < z \leq D ) \\ - {μ}_{0} [ {E}_{x} ( σ D + {σ}^{′} [ z - D ] ) + \frac{σ {v}_{0} {F}_{z} {z}_{0}}{2} ] , & ( D < z \leq D + {D}^{′} )\end{matrix} & ( 109 )\end{matrix}$$

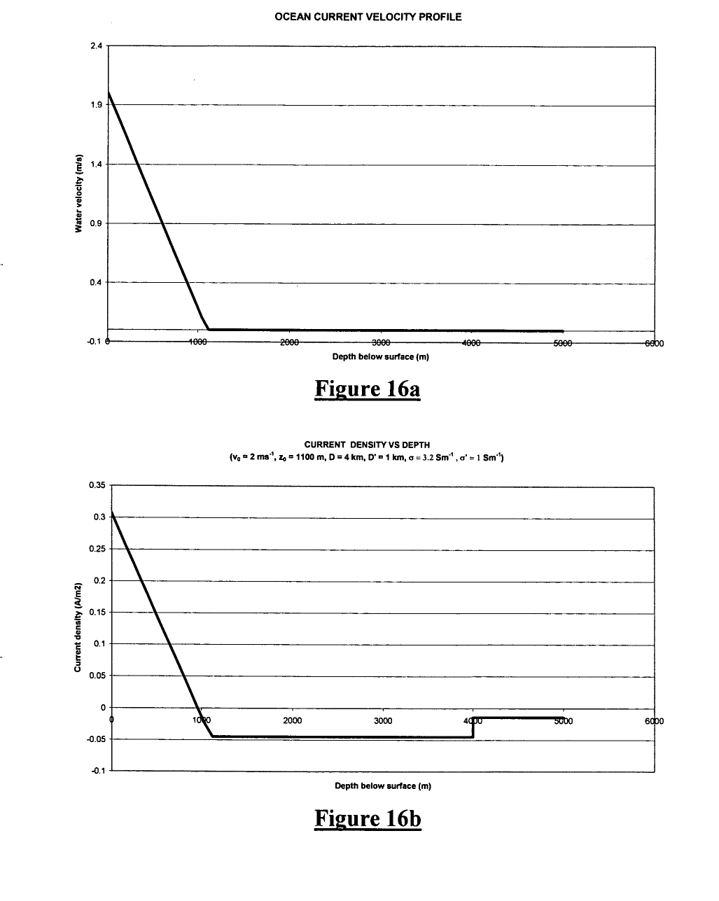

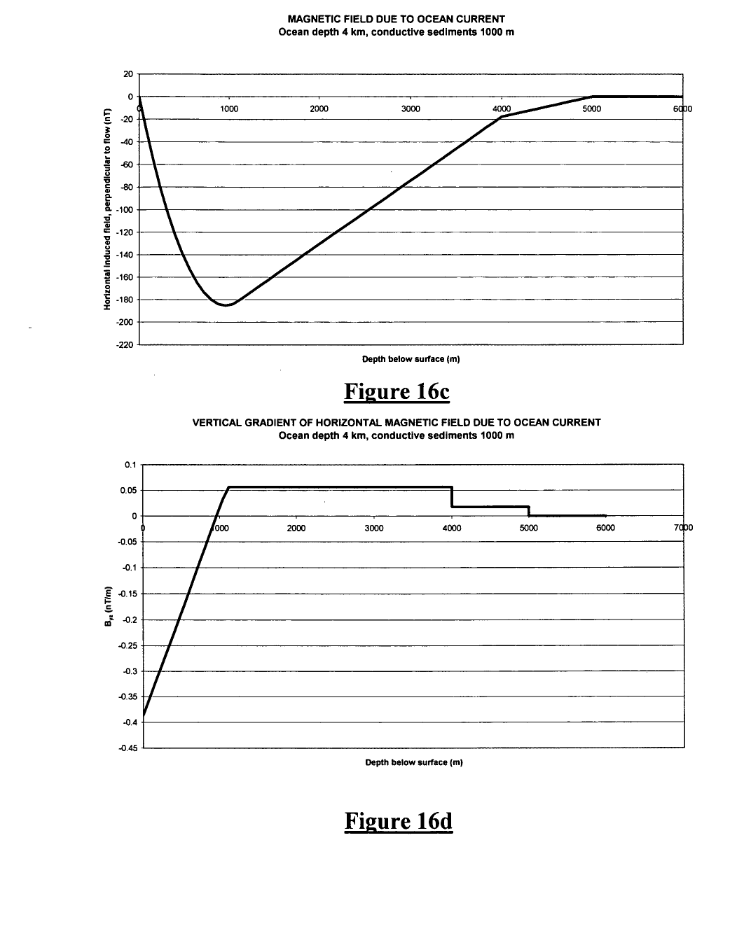

FIGS. 16a to 16d are plots of velocity, electric current, magnetic field and magnetic field gradient, respectively, versus depth, for the case where v₀=2 ms⁻¹ and z₀=1100 m, in a 4 km deep (σ=3.2 Sm⁻¹) ocean with a 1 km thick conductive (σ′=1 Sm⁻¹) seafloor. The vertical geomagnetic field is 55,000 nT. The barotropic velocity is 0.275 ms⁻¹ and the leakage correction factor is 1.078. The electric field is −14 μVm⁻¹, the maximum current density and the corresponding maximum magnetic gradient (at the surface) are 0.31 mAm⁻² and −0.39 nTm⁻¹ respectively. The current density and magnetic gradient tensor element b_{yz} change sign at 1000 m depth. Below 1100 m, where there is no water flow, b_{yz} has a constant value of 56 pTm⁻¹ down to the seafloor, dropping to 18 pTm⁻¹ within the conductive seafloor zone. The magnetic field, which is directed along the negative y axis, is zero at the surface, attains its maximum strength of 185 nT at 1000 m depth, and thereafter decreases linearly with depth to 18 nT on the seafloor, with a further slow linear decrease to zero at the base of the conductive seafloor zone.

### Magnetic Field and Gradient Measurements in the Conductive Oceanic Medium

The presence of electric current distributions within a conductive medium changes the structure of the magnetic gradient tensor fundamentally. In air or free space the gradient tensor is both traceless and symmetric. In the presence of conduction currents the curl of B is non-zero and the gradient tensor is asymmetric. This raises the question of what is actually measured by magnetometers and gradiometers immersed in the electrically conductive ocean. In particular, it is to be determined how the signal measured within a sealed capsule relates to the field components and tensor elements that existed in the surrounding medium prior to insertion of the measurement package.

We will show that the answer to this question depends on the configuration of the sensors, in particular whether conduction currents flow between individual sensors or the entire sensor package is contained within an insulating capsule. For simplicity we consider the fields and gradients inside a spherical cavity within an effectively infinite conducting medium. Although this geometry is simple in principle, a difficulty arises because the magnetic field configuration inside an infinite current distribution is not unique, but depends on the shape of the assumed bounding surface of the current distribution as the dimensions of the boundary increase without limit.

As an example, consider the magnetic field within an infinitely long cylinder, with a uniform current density along its axis. The magnetic field forms closed loops, centred on the axis of the cylinder, which allows the field strength to be calculated simply from Ampere's circuital law. This field geometry persists as the radius of the cylinder is allowed to increase without limit, suggesting that the magnetic field within an infinite uniform current distribution forms closed loops in the plane normal to the current flow. The circulation of the azimuthal field (B_{φ}) around a circular loop of radius r centred on the axis of symmetry, which is simply 2πrB_{φ}, is equal to μ₀ times the total current through the loop. Because the current through the loop is simply the current density multiplied by the area πr² of the loop, the field is given by B_{φ}=μ₀jr/2. This field distribution produces an antisymmetric gradient tensor. The only non-zero components are the off-diagonal elements in the plane normal to the current flow, which are equal in magnitude and opposite in sign (e.g. B_{yz}=μ₀jₓ/2=−B_{zy}, if the current is parallel to the x axis).

By contrast, consider a uniform current distribution within an infinite horizontal sheet. This geometry produces a horizontal magnetic field, perpendicular to the current flow, which is independent of horizontal co-ordinates, but varies linearly with vertical position. This configuration, which is radically different from the situation discussed above, persists as the vertical thickness of the sheet increases without limit. In this case the gradient tensor is asymmetric, with one non-zero component (e.g. B_{yz}=−μ₀jₓ; B_{zy}=0, if the current is parallel to the x axis and z is vertical).

The magnetic fields for these two situations differ by a vector field that is proportional to (0, z, y), which has zero divergence and curl and thus does not affect Maxwell's equations. The difference in their gradients is proportional to the gradient of (0, z, y), which is a constant symmetric tensor. These two cases of “infinite” current distributions with differing field configurations and gradients illustrate the necessity to consider the symmetry of the physical problem before attempting to calculate the fields and gradients in and around a spherical cavity within an “infinite” current distribution.

These subtleties do not affect the calculation of the current flow around a spherical cavity of radius a, within an infinite conductive medium with a steady, uniform applied electric field E₀=E₀\hat{x}. The electric field produces a uniform current distribution, j₀=j₀\hat{x}, far from the perturbing influence of the cavity. It is convenient to use spherical polar co-ordinates for this problem, with the polar axis along \hat{x} and the origin at the centre of the spherical cavity. The medium is taken to be at rest, so there is no Lorentz electric field arising from motion within the magnetic field. In the absence of time-varying fields E is equal to −∇V, where V is the electric potential. V satisfies Laplace's equation everywhere (except on the surface of the cavity), is symmetric about the x axis, is regular at infinity and at the origin, is continuous at the boundary of the cavity and is further constrained by the condition that the radial component of the external field vanishes as r→a. This last condition follows from the proportionality of E and j outside the cavity and the requirement that there is no current flow into the cavity. Thus we have:

$$\begin{matrix}E = - ∇ V , where & ( 110 ) \\ {∇}^{2} V = 0 ( r \neq a ) , & ( 111 ) \\ \frac{\partial V}{\partial ϕ} = 0 , & ( 112 ) \\ V -> - {E}_{0} x = - {E}_{0} r cos θ as r -> ∞ , & ( 113 ) \\ V \neq ∞ as r -> 0 , & ( 114 ) \\ V ( r = {a}^{+} ) = V ( r = {a}^{-} ) , and & ( 115 ) \\ {E}_{r} = - \frac{\partial V}{\partial r} -> 0 as r -> a . & ( 116 )\end{matrix}$$

Solutions of (111) that satisfy all the boundary conditions are:

$$V = \{ \begin{matrix}- {E}_{0} r cos θ - \frac{{E}_{0} {a}^{3} cos θ}{2 {r}^{2}} , & ( r \geq a ) \\ \frac{- 3 {E}_{0} r cos θ}{2} & ( r \leq a )\end{matrix} \qquad ( 117 )$$

The corresponding electric field components are:

$$\begin{matrix}{E}_{r} = - \frac{\partial V}{\partial r} = \{ \begin{matrix}{E}_{0} cos θ ( 1 - \frac{{a}^{3}}{{r}^{3}} ) & ( r \geq a ) \\ \frac{3 {E}_{0} cos θ}{2} & ( r \leq a )\end{matrix} & ( 118 ) \\ {E}_{θ} = - \frac{1}{r} \frac{\partial V}{\partial θ} = \{ \begin{matrix}- {E}_{0} sin θ ( 1 + \frac{{a}^{3}}{2 {r}^{3}} ) & ( r \geq a ) \\ \frac{- 3 {E}_{0} sin θ}{2} & ( r \leq a )\end{matrix} & ( 119 ) \\ {E}_{x} = - \frac{\partial V}{\partial x} = \{ \begin{matrix}{E}_{0} ( 1 - \frac{{a}^{3} ( 3 {cos}^{2} θ - 1 )}{{r}^{3}} ) & ( r \geq a ) \\ \frac{3 {E}_{0}}{2} & ( r \leq a )\end{matrix} & ( 120 ) \\ {E}_{y} = - \frac{\partial V}{\partial y} = \{ \begin{matrix}\frac{- 3 {E}_{0} {a}^{3} cos ϕsinθcosθ}{2 {r}^{3}} & ( r \geq a ) \\ 0 & ( r \leq a )\end{matrix} & ( 121 ) \\ {E}_{z} = - \frac{\partial V}{\partial z} = \{ \begin{matrix}\frac{- 3 {E}_{0} {a}^{3} sin ϕsin θcos θ}{2 {r}^{3}} & ( r \geq a ) \\ 0 & ( r \leq a )\end{matrix} & ( 122 )\end{matrix}$$

The electric field inside the cavity is uniform, parallel to the applied field, and 50% stronger. Outside the cavity the effect of the cavity is equivalent to the field of a reversely polarised dipole with moment p=−2π∈₀E₀a³, i.e.

$$\begin{matrix}{E}_{r}^{′} = \{ \begin{matrix}\frac{2 p cos θ}{4 {πɛ}_{0} {r}^{3}} = - \frac{{E}_{0} {a}^{3} cos θ}{{r}^{3}} & ( r \geq a ) \\ \frac{{E}_{0} cos θ}{2} & ( r \leq a )\end{matrix} & ( 123 ) \\ {E}_{θ}^{′} = \{ \begin{matrix}\frac{p sin θ}{4 {πɛ}_{0} {r}^{3}} = \frac{- {E}_{0} {a}^{3} sin θ}{2 {r}^{3}} & ( r \geq a ) \\ \frac{- {E}_{0} sin θ}{2} & ( r \leq a ) ,\end{matrix} & ( 124 )\end{matrix}$$

where E′ is the field arising from the cavity. It follows from (118)-(124) that the electric field distribution everywhere is identical to that which would be produced if the spherical cavity had a permanent polarisation P=−3∈₀E₀/2. The resultant field is simply the superposition of the field of a polarised sphere (a dipole field externally and a uniform internal field equal to −P/3∈₀=E₀/2) and the uniform applied field. Another way of stating the effect of the cavity is that initiation of the current flow produces an accumulation of charge on the surface of the cavity, which thereafter deflects the field and associated current flow around the outside of the cavity. The steady state current flow corresponds to a surface charge density ζ=P ·\hat{r}=−3∈₀E₀ cos θ/2.

As discussed above the magnetic field arising from the uniform current distribution associated with the uniform applied electric field depends on the implicitly assumed symmetry. Because the lateral extent of the open ocean far exceeds its depth, it is appropriate to represent the sea water by a horizontal slab of infinite lateral extent. Since electric currents cannot penetrate the sea surface, the steady state electric field is horizontal near the surface and can be taken as essentially horizontal throughout the water column, especially when the sea floor is flat. For simple, but reasonably realistic, situations, such as rectilinear water flow as a function of depth only in a flat-bottomed ocean, the electric field is horizontal and constant throughout the water column.

The magnetic field arising from an infinite horizontal sheet of current can be calculated directly from symmetry considerations and ∇×b=μ₀j, or by using Ampere's circuital law for rectangular contours bounding surfaces that are perpendicular to the current flow. The fields above and below the sheet are uniform, equal in magnitude, and oppositely directed, perpendicular to the current flow. The sense of the fields is given by the right hand rule (if the thumb indicates the current flow, the fingers show the field lines). If the current flow is along x and z is down, the field is directed along +y above the slab and −y below the slab, assuming a right-handed co-ordinate system. Within the current distribution the vertical gradient of B_{y} is constant, so the field varies linearly from top to bottom of the slab. Thus the magnetic field due to uniform horizontal current flow in a water column of depth D is:

$${( {B}_{0} )}_{y} = \{ \begin{matrix}+ \frac{{μ}_{0} {j}_{x} D}{2} & ( z \leq {z}_{1} ) , \\ {μ}_{0} {j}_{x} [ \frac{D}{2} - z + {z}_{1} ] & ( {z}_{1} \leq z \leq {z}_{1} + D ) , \\ - \frac{{μ}_{0} {j}_{x} D}{2} & ( z \geq {z}_{1} + D ) ,\end{matrix} \qquad ( 125 )$$

where the current distribution is confined to z₁≦z≦z₁+D.

The corresponding gradient tensor is zero above and below the current distribution. Within the current flow it is:

$${( {B}_{0} )}_{ij} = [ \begin{matrix}0 & 0 & 0 \\ 0 & 0 & - {μ}_{0} {j}_{x} \\ 0 & 0 & 0\end{matrix} ] ( 0 \leq z \leq D ) , \qquad ( 126 )$$

which is asymmetric. Equation (126) is valid for any horizontal current distribution jₓ(z) that varies arbitrarily with depth, but is independent of horizontal co-ordinates. For such a current distribution the field is then given by the vertical integral of (B₀)_{yz}, as discussed in the section on the effects of ocean currents.

If a small spherical cavity is introduced into this distribution, the perturbation of the current flow around the cavity is, from (123)-(124):

$$\begin{matrix}{j}_{r}^{′} = σ {E}_{r}^{′} = - \frac{σ {E}_{0} {a}^{3} cos θ}{{r}^{3}} \\ {j}_{θ}^{′} = σ {E}_{θ}^{′} = - \frac{σ {E}_{0} {a}^{3} cos θ}{{r}^{3}} \\ {j}_{ϕ}^{′} = 0 \\ {j}_{x}^{′} = σ {E}_{x}^{′} = \frac{- σ {E}_{0} {a}^{3} ( 3 {cos}^{2} θ - 1 )}{{r}^{3}} \\ {j}_{y}^{′} = σ {E}_{y}^{′} = \frac{- 3 σ {E}_{0} {a}^{3} cos ϕsin θcos θ}{2 {r}^{3}} \\ {j}_{z}^{′} = σ {E}_{z}^{′} = \frac{- 3 σ {E}_{0} {a}^{3} sin ϕ sin θ cos θ}{2 {r}^{3}}\end{matrix} \} ( r \geq a ) \qquad ( 127 )$$

For this treatment to be accurate, the diameter of the spherical cavity must be small relative to the scale of vertical variations in the current flow and the sphere must lie several diameters from the boundaries of the current distribution.

The current distribution everywhere, inside as well as outside the cavity, is given by the superposition of the uniform current distribution, j₀=j₀\hat{x}, of the unperturbed medium and a perturbing distribution that is given by (127) outside the cavity and is equal and opposite to j₀ inside the cavity, i.e.

$$\begin{matrix}{j}_{r}^{′} = - {j}_{0} cos θ \\ {j}_{θ}^{′} = {j}_{0} sin θ \\ {j}_{ϕ}^{′} = 0 \\ {j}_{x}^{′} = - {j}_{0} \\ {j}_{y}^{′} = 0 \\ {j}_{z}^{′} = 0\end{matrix} \} ( r \leq a ) \qquad ( 128 )$$

The complete current distribution j′ given by (127)-(128) is physically realistic and consistent with steady state conditions, because the radial component of j′ is continuous across the boundary of the sphere and therefore no accumulation of charge, which would cause a time-varying electric field, occurs.

The magnetic field inside and outside the cavity can now be determined as the superposition of the field arising from j₀ alone, given by (125) and the field associated with the current distribution j′. The axial symmetry of j′ allows us to use Ampere's circuital law to determine the associated magnetic field, which forms closed loops centred on the axis of symmetry (along the x axis, passing through the centre of the sphere). Inside the cavity this gives:

$$\begin{matrix}{B}_{ϕ}^{′} = \frac{- {μ}_{0} {j}_{x} r sin θ}{2} = \frac{- {μ}_{0} {j}_{x} \sqrt{{y}^{2} + {z}^{2}}}{2} \\ {B}_{y}^{′} = \frac{{μ}_{0} {j}_{x} z}{2} \\ {B}_{z}^{′} = - \frac{{μ}_{0} {j}_{x} y}{2} \\ {B}_{yz}^{′} = \frac{{μ}_{0} {j}_{x}}{2} \\ {B}_{zy}^{′} = - \frac{{μ}_{0} {j}_{x}}{2}\end{matrix} \} ( r \leq a ) \qquad ( 129 )$$

as the non-zero components of the field and gradient tensor.

Equation (129) shows that along the axis of symmetry (y=z=0), and in particular in the centre of the cavity, B′=0. Within the cavity the gradient tensor is constant.

The magnetic field b and gradient tensor bᵢⱼ measured within a spherical cavity inserted into an originally uniform current distribution are now determined:

$$\begin{matrix}b = {B}_{0} + {B}^{′} = ( 0 , \frac{{μ}_{0} {j}_{x}}{2} [ D - z + 2 {z}_{1} ] , - {μ}_{0} {j}_{x} y / 2 ) & ( 130 ) \\ {b}_{ij} = {( {B}_{0} )}_{ij} + {B}_{ij}^{′} = [ \begin{matrix}0 & 0 & 0 \\ 0 & 0 & \frac{- {μ}_{0} {j}_{x}}{2} \\ 0 & \frac{- {μ}_{0} {j}_{x}}{2} & 0\end{matrix} ] & ( 131 )\end{matrix}$$

Therefore the effect of the cavity can be summarised as follows:
The electric field within the cavity is uniform, parallel to the unperturbed applied field and larger by a factor of 1.5 (see (120)).
The magnetic field at the centre of the cavity is equal to the unperturbed magnetic field that existed at the same point in the conductive medium, prior to insertion of the measurement capsule (see (125) and (130)).
The symmetric magnetic gradient tensor within the cavity is uniform. The only non-zero components are b_{yz}=b_{zy} (see (131)). These components are each equal to half the value of (B₀)_{yz} that is produced by the unperturbed current flow (126). The current density in the medium, prior to insertion of the measurement capsule, is given by:

$${j}_{x} = \frac{- 2 {b}_{yz}}{{μ}_{0}} . \qquad ( 132 )$$

Equation (132) provides a way of determining the local electric current flow within the sea water, provided magnetic gradients arising from other sources can be distinguished. The total measured gradient tensor within a spherical cavity comprises the gradient tensor due to distant sources, plus the tensor bᵢⱼ given by (131), which reflects the local current distribution. Only off-diagonal components within the plane perpendicular to the electric current flow are influenced by the local current density.

Although results have been derived only for a specific shape of measurement capsule, clearly measurements of electric and magnetic fields within sealed capsules of different shape will also reflect the unperturbed fields and therefore can provide information about local electric current distributions in the ocean. For example a capsule in the form of a flat-lying horizontal disc produces negligible perturbation of the electric currents and, by the boundary conditions on E and B, will have electric and magnetic fields identical to those in the surrounding sea water. The electric current flow in the adjacent medium produces zero gradient within the cavity in this case. It follows that the measured gradient within such a cavity reflects only distant sources and is unaffected by the local current distribution.

A vertical thin disc that is aligned with the flow also has internal E and B fields equal to the unperturbed external fields. Continuity of the normal component of B, i.e. B_{y}, across the walls of the capsule implies that the vertical gradient of B_{y} arising from the current density, i.e. B_{yz}=μ₀jₓ, is also equal within and without the capsule. Because B is irrotational within the capsule, B_{zy} is also equal to −μ₀jₓ inside the capsule, for this orientation of the disc.

These specific examples, and the general principle that an ellipsoidal cavity in a uniform current flow will generate a uniform electric field within the cavity (by analogy with ellipsoidal conductors and dielectric ellipsoids in a uniform field), indicate that the electric field within any cavity with regular shape should be directly proportional to the applied field. The magnetic case appears to be more complex, but a cavity in the form of a rotational ellipsoid, or close analogue such as a disc, cylinder or prism, should have internal fields and gradients that are simply related to the external fields and gradients due to the current flow, provided the axis of symmetry is aligned with the electric current.

The simplest configuration of sensors for correction of CSEM measurements for wave-induced noise uses distributed sensors with an essentially unperturbed flow of electric current through the sea water separating the sensors, rather than a complete gradiometer within an enclosed capsule. This idealised situation is approximated, for example, by an array of sensors on long thin arms protruding from a small capsule that contains a power supply and data acquisition system, or by gradiometers consisting of sensors mounted at the ends of a thin rod. Magnetic gradients are obtained by subtraction of magnetic field measurements at different sensors, without any need for geometric corrections.

The section on effects on ocean currents shows that fields up to several hundred nT and gradients of several hundred pTm⁻¹ can result from oceanic flows. Thus information on oceanic currents can be obtained from magnetometry/gradiometry in the ocean. A corollary is that magnetic measurements for other purposes, such as seafloor exploration, are affected by ocean currents. Therefore signals of different origin need to be distinguished, so that appropriate corrections can be applied.

### Use of Magnetic Gradients to Correct EM Measurements for Wave-Related Noise

The analysis of the magnetic field and its gradients within a spherical cavity, immersed in a uniform static current density, relies on equation (30), which is applicable whenever displacement currents are negligible. Thus we can also apply (129) to the quasistatic electric currents that are generated by ocean waves, noting that in this case the slowly oscillating currents are parallel to the y axis (for wave propagation along the +x direction). Then, within a measurement capsule with dimensions that are small compared to λ, the non-zero components of the gradient tensor that oscillate at the frequency of the wave motion are:

$$\begin{matrix}{b}_{xx} ( ω ) = - {b}_{zz} ( ω ) = - i {kb}_{x} ( ω ) = - i {k ( {B}_{0} )}_{x} ( ω ) ( all cases ) & ( 133 ) \\ {b}_{xz} ( ω ) = {b}_{zx} ( ω ) = - i {kb}_{z} ( ω ) = - i {k ( {B}_{0} )}_{z} ( ω ) \\ ( horizontal disc , or discrete sensors ) & ( 134 ) \\ {b}_{xz} ( ω ) = {b}_{zx} ( ω ) = - i {k ( {B}_{0} )}_{z} ( ω ) + \frac{{μ}_{0} {j}_{y} ( ω )}{2} ( spherical cavity ) & ( 135 ) \\ {b}_{xz} ( ω ) = {b}_{zx} ( ω ) = i {k ( {B}_{0} )}_{z} ( ω ) + {μ}_{0} {j}_{y} ( ω ) \\ ( vertical disc ⊥ propagation ) & ( 136 )\end{matrix}$$

where the components of the oscillating wave-induced field, B₀, in the sea water, prior to insertion of the measurement capsule, are given by (49) and (51), or the corresponding approximate expressions (54)-(55), and the current density is given by (77) or (79). The simplest case is for discrete sensors separated by the conductive medium, for which all measured gradient tensor elements are essentially unperturbed

Identification of a wave-induced gradient signal in a narrow frequency band allows the wave-induced fields to be estimated using (133)-(136). First the measured tensor is diagonalised to determine the orientation of the wave crests (the y axis). The eigenvector that corresponds to zero eigenvalue (in practice the eigenvalue with the smallest absolute value) indicates the y axis. Then:

$${( {B}_{0} )}_{x} ( f ) = \frac{i {b}_{xx} ( f )}{k} = \frac{i {gb}_{xx} ( f )}{4 {π}^{2} {f}^{2}} , \qquad ( 137 )$$

for all three shapes of measurement capsule. Thus the horizontal field fluctuations at a specific frequency can be determined directly from bₓₓ, independent of the physical properties of the sea water.

$$\begin{matrix}Also , & \\ {( {B}_{0} )}_{z} ( f ) = \frac{i [ {b}_{xz} ( f ) - G {μ}_{0} {j}_{x} ( f ) ]}{k ( f )} \\ ∴ {( {B}_{0} )}_{z} ( f ) = \frac{i {gb}_{xz} ( f )}{4 {π}^{2} {f}^{2}} \{ \frac{\begin{matrix}2 {e}^{- kz \sqrt{1 + i β}} - \\ {e}^{- kz} ( 1 + \sqrt{1 + i β} )\end{matrix}}{\begin{matrix}2 ( 1 + i G β ) {e}^{- kz \sqrt{1 + i β}} - \\ {e}^{- kz} ( 1 + \sqrt{1 + i β} )\end{matrix}} \} , & ( 138 ) \\ where & \\ β = \frac{{μ}_{0} σ {g}^{2}}{8 {π}^{3} {f}^{3}} , & ( 139 ) \\ β k = \frac{{μ}_{0} σ g}{2 π f} , & ( 140 )\end{matrix}$$

and G is a geometric factor:

G=0 (horizontal disc, or discrete sensors)

G=½ (sphere)

G=1 (vertical disc⊥propagation). (141)

For all cases of interest β<<1 and βkz=4π²f²z/g<1. For instance, taking f=0.1 Hz (corresponding to λ=156 m, k=0.04 m⁻¹), σ=4 Sm⁻¹, g=9.8 ms⁻¹ and μ₀=4π×10⁻⁷, gives β=1.9×10⁻³, and βkz<0.3 for z<3950 m. Then (138) becomes, to first order in β:

$$∴ {( {B}_{0} )}_{z} ( f ) = \frac{i {gb}_{xz} ( f )}{4 {π}^{2} {f}^{2}} \{ \frac{2 {e}^{- iβ kz / 2} - 2 - iβ / 2}{2 ( 1 + i G β ) 2 {e}^{- iβ kz / 2} - 2 - iβ / 2} \} . \qquad ( 142 )$$

For βkz<<1, (142) reduces to:

$$\begin{matrix}∴ {( {B}_{0} )}_{z} ( f ) = \frac{i {gb}_{xz} ( f )}{4 {π}^{2} {f}^{2}} \{ \frac{2 kz + 1}{2 kz + 1 - 4 G} \} \\ = \frac{i {gb}_{xz} ( f )}{4 {π}^{2} {f}^{2}} \{ \frac{8 {π}^{2} {f}^{2} z / g + 1}{8 {π}^{2} {f}^{2} z / g + 1 - 4 G} \} .\end{matrix} \qquad ( 143 )$$

Provided an estimate of the conductivity (either measured directly or calculated from salinity and temperature) is available, the parameters β and βk are given by (139)-(140). Thus equations (137) and (142) can be used to determine the magnetic fields produced by wave motions from the measured gradient tensor components. Equation (142) shows that even approximate knowledge of the conductivity allows determination of the fields from measured gradients with reasonable accuracy, because the dependence of the vertical field on conductivity, via the parameter β, is only weak. When (143) is applicable, the calculated vertical field is independent of conductivity.

Because other sources of low frequency (but not DC) magnetic field produce negligible gradients, this method effectively isolates the oceanographic magnetic noise and allows it to be removed from the measured magnetic fields. Measured electric fields can also be corrected for wave-motion noise, by using equation (96), with C=g/2πf.

For example, at depth D=300 m, swells with a wavelength of 400 m generate magnetic field oscillations at 0.06 Hz with amplitudes from 0.15 nT to a maximum of 1.8 nT for wave amplitudes ranging from one metre to the maximum of 12.5 m. The corresponding gradient oscillations have amplitudes of 2-30 pT/m and the amplitudes of the electric field oscillations range from ˜4 nV/m to ˜45 nV/m. The electric and magnetic field noise at this depth due to wave motions can therefore be significant.

The ability to correct for the wave-induced electric and magnetic fields may significantly improve signal-to-noise ratios for marine electromagnetic exploration. Measurement of the magnetic gradient tensor can contribute to suppression of electromagnetic noise due to wave motions in two ways. Firstly, identification of gradient fluctuations above the instrumental noise level within a relatively narrow frequency band in the range 0.05-0.2 Hz can facilitate the design of filters designed to suppress wave-induced noise, over the same range of frequencies, from the measured electric and magnetic fields. One way in which this can be accomplished is by interpolating the ocean wave-induced effects from frequencies around, but not coincident with, the frequency components of the CSEM signal, in order to estimate and then remove the ocean wave-induced effects from the measured signal at the CSEM frequencies. Secondly, well-defined gradient tensor fluctuations can be used to directly calculate the corresponding wave-induced magnetic and electric fields and remove them from the measured data.

Measurements of the horizontal gradients of the total field can also be used to determine wave motion field components. For βkz<<1, we get from (54), (55) and (67):

$$\begin{matrix}{b}_{z} = \frac{( i cos θ cos I + sin I ) ( 2 kz + 1 ) {b}_{T}}{\begin{matrix}( {cos}^{2} {θcos}^{2} I + {sin}^{2} I ) ( 1 - 2 kz ) + \\ 4 kz sin I ( sin I + i cos θ cos I )\end{matrix}} ( z > 0 ) , & ( 144 ) \\ {b}_{x} = \frac{i ( i cos θcos I + sin I ) ( 2 kz - 1 ) {b}_{T}}{\begin{matrix}( {cos}^{2} {θcos}^{2} I + {sin}^{2} I ) ( 1 - 2 kz ) + \\ 4 kz sin I ( sin I + i cos θ cos I )\end{matrix}} ( z > 0 ) . & ( 145 )\end{matrix}$$

Differentiating (67) with respect to x gives:

$$\begin{matrix}\frac{\partial {b}_{T}}{\partial x} = - i {kb}_{T} . & ( 146 ) \\ ∴ {b}_{z} ( f ) = \frac{i g ( i cos θ cos I + sin I ) ( \frac{8 {π}^{2} {f}^{2} z}{g} + 1 ) \frac{\partial {b}_{T}}{\partial x} ( f )}{\begin{matrix}4 {π}^{2} {f}^{2} ( {cos}^{2} {θcos}^{2} I + {sin}^{2} I ) ( 1 - \frac{8 {π}^{2} {f}^{2} z}{g} ) + \\ \frac{64 {π}^{4} {f}^{4} z}{g} sin I ( sin I + i cos θ cos I )\end{matrix}} , & ( 147 ) \\ {b}_{x} ( f ) = \frac{- g ( i cos θ cos I + sin I ) ( \frac{8 {π}^{2} {f}^{2} z}{g} - 1 ) \frac{\partial {b}_{T}}{\partial x} ( f )}{\begin{matrix}4 {π}^{2} {f}^{2} ( {cos}^{2} {θcos}^{2} I + {sin}^{2} I ) ( 1 - \frac{8 {π}^{2} {f}^{2} z}{g} ) + \\ \frac{64 {π}^{4} {f}^{4} z}{g} sin I ( sin I + i cos θ cos I )\end{matrix}} , & ( 148 )\end{matrix}$$

where we have used (144)-(146) and the relationship k=4π²f²/g. Thus by measuring the fluctuations of the horizontal gradient of the total field in the direction of propagation, which arise almost entirely from wave motions, the wave-induced magnetic field components can be determined.

### Removal of Wave Noise Using Fourier Analysis

For a sinusoidal water wave of amplitude A, frequency f, the instantaneous sea surface height with respect to mean sea level, ζ(t), is:

ζ(t)=Aexp(i2πft) (149)

where i=√(−1). The origin of time can be chosen to yield the correct phase for the wave. It is understood that only the real part of the RHS of (149) is equated to the LHS.

At a fixed point an arbitrary waveform can be represented as a superposition of its Fourier components:

$$ζ ( t ) = {\int }_{- ∞}^{∞} \tilde{A} ( f ) exp [ i2π ft ] d f , \qquad ( 150 )$$

where the Fourier coefficients Ã(f) are given by:

$$\tilde{A} ( f ) = {\int }_{- ∞}^{∞} ζ ( t ) exp [ - i 2 π ft ] d t . \qquad ( 151 )$$

Similarly the frequency components of the measured fields and gradients are obtained from the Fourier transform of the corresponding time series, e.g.

$$\frac{\partial {\tilde{b}}_{T}}{\partial x} ( f ) = {\int }_{- ∞}^{∞} \frac{\partial {b}_{T}}{\partial x} ( t ) exp [ - i 2 π ft ] d t , \qquad ( 152 )$$

and analogously for the other time series. The spectrum of the total magnetic field is heavily biased towards low frequencies, compared to the spectrum of the wave motion, due to the faster water motion through the geomagnetic field for low frequency/long wavelength waves and the rapid attenuation of short wavelength fields away from the surface. The dominance of low frequencies is somewhat less for the magnetic gradients, because differentiating the field is equivalent to multiplying the spectrum by k=2π/λ, which is proportional to f², by equation (14).

To determine the time-varying magnetic field components produced by wave motions alone, essentially independently of other sources of magnetic field variation, including geomagnetic noise and the CSEM signal, the Fourier components of the horizontal total field gradient are calculated from the measured time series using (152). Substitution of the calculated spectrum into equations (147) and (148) determines the spectrum of the vertical and horizontal field components respectively. The corresponding time series can then be calculated using the inverse Fourier transform, analogous to (150). Subtraction of these calculated time series from the measured field components removes much of the wave-induced noise in the field components.

### Magnetometer Resolutions and Noise Levels

The resolution of a magnetometer is the smallest field difference it can measure, which may be greater than the nominal field difference corresponding to the last decimal place that is displayed or logged. In most cases successive measurements of a slowly changing field exhibit random fluctuations about the mean trend that exceed the resolution, due to noise. The noise level is not always defined correctly or presented unambiguously, but should be calculated as the square root of the noise power per unit measurement bandwidth, the definition that is followed here. Thus the noise is specified in units such as nT/√Hz. This enables the root-mean-square (rms), or standard deviation, of the field to be calculated directly for a specified sampling rate. Comparison of different types of magnetometer, and even different makes of the same type, are complicated by inconsistency of specification. In particular, the concept of “sensitivity” is quite nebulous. The fairest definition of sensitivity is the resolution or the rms noise at the specified sampling rate, whichever is the higher.

The noise characteristics of total field sensors, such as proton precession, Overhauser and optical pumping (Cs, Rb, K and He) magnetometers, are quite different from those of vector sensors like SQUIDS and fluxgates. For total field magnetometers the resolution is determined by the number of Larmor cycles that are counted during the measurement. For example, if the frequency that is counted (the Larmor frequency or its electronically generated multiple) in a field of 50 μT is 200,000 Hz and the measurement rate is 5 Hz, then 40,000 Larmor cycles are counted per measurement, allowing the field to be resolved to one part in 40,000, or 1.25 nT. If the measurement cycle is increased from 0.2 to 10 seconds, this resolution improves to one part in two million, or 0.0025 nT.

Total field magnetometers measure the average field during the measurement cycle, provided the slew rate of the electronics is not exceeded. Assuming the field does not change significantly during the measurement, there are clear advantages in counting for longer times to achieve higher resolution.

One very important feature of total field magnetometers is that they are more-or-less absolute instruments that exhibit negligible long term drift. As a consequence, their noise spectrum is flat, i.e. it is white at all frequencies. This is quite different from SQUIDS and fluxgates, which exhibit white noise only at relatively high frequencies, greater than ˜1 Hz, with a distinctly red spectrum, showing an approximate 1/f dependence of noise, at lower frequencies.

In order to convert specified noise figures for magnetometers into standard deviation of the measured field, the measurement bandwidth is required. This is very simple for total field magnetometers. Due to the nature of the measurement process, where many cycles of a frequency modulated signal are counted, the measurement bandwidth is simply the Nyquist frequency of the measurement, i.e. half the sampling frequency. For a measurement cycle of one second, the Nyquist frequency is 0.5 Hz. The rms field measured, in nT, is then the noise (in nT/√Hz) multiplied by √(0.5 Hz).

For example, the specified noise of a SeaSPY Overhauser magnetometer operating at 1 Hz is 15 pT/√Hz. Thus the standard deviation of 1 Hz measurements is predicted to be 15√(0.5)=11 pT, whereas 2 Hz sampling would have rms noise of 15 pT. Conversely a slower measurement cycle of 5 s, corresponding to a Nyquist frequency of 0.1 Hz, will give reduced rms noise of 15√(0.1)=5 pT.

For comparison, the specified white noise level of a low noise Bartington fluxgate at 1 Hz is 5 pT/qHz, which predicts rms noise of 3.5 pT for 1 s sampling. However at much lower frequencies, the noise performance of a static fluxgate will be inferior to that of a total field magnetometer. For example, the noise at 0.001 Hz is still 15 pT/√Hz for the Overhauser magnetometer, whereas fluxgate noise, assuming 1/f dependence for <1 Hz, is ˜5 nT/√Hz at this frequency. Spinning the fluxgate can potentially overcome this blow-out in noise, by shifting the effective measurement frequency back to the white noise region, as well as allowing substantial signal stacking. Another way of looking at this noise reduction technique is to recognise that rotating a fluxgate through 180° enables the offset to be determined, yielding the absolute value of the field component. Continuously performing this process eliminates all long term drift of the offset, which is the time domain equivalent of the 1/f noise.

In addition, because the field component is measured at many different orientations during the rotation, many independent estimates of the field are made, allowing the standard error of the measurement to be substantially reduced. In the frequency domain, this can be regarded as reducing the measurement bandwidth by narrowband detection at the fundamental frequency. We are only interested in the noise power at the rotation frequency—the rest of the noise power is distributed among all the frequency components up to the Nyquist frequency of the sampling of successive orientations. In other words, instead of a bandwidth equal to the Nyquist frequency associated with the sampling rate of a static sensor, the measurement bandwidth becomes the frequency resolution of the Fourier transform of the time series, which is 1/T, where T is the total spin time per reading.

As an example, consider a Bartington low noise fluxgate rotating at 1 Hz, with 1024 measurements per rotation and signal stacking for 10 spins. The sampling rate of the fluxgate is 1024 Hz, which gives a Nyquist frequency of 512 Hz and a total noise power, evenly distributed over 0-512 Hz, of (5 pT/√Hz)²×512 Hz. However the detection bandwidth is 0.1 Hz, so the noise power at the fundamental frequency is only 2.5 (pT)², corresponding to rms noise of √2.5)=1.6 pT. Stacking of 1024 independent weighted estimates of B gives a standard error on the stacked measurements of 1.6/√1024 pT=50 fT every 10 seconds. It should be noted that practical attainment of this spectacular reduction in noise level is not trivial and requires precise synchronous detection and accurate angular orientation.

### Controlled Source Electromagnetics

CSEM signals are intrinsically very weak and their measurement relies on narrow signal bandwidth, as opposed to broadband noise, and stacking of the signal. A typical CSEM survey operates at 0.25 Hz with stacking for 40 periods, i.e. 160 seconds. During this time the transmitter, at a tow speed of 1.5 knots, traverses about 80 m, which is only about a tenth of the shortest wavelength present in the signal, so the stacked data within each 160 s overlapping window can be regarded as acquired at a single location. We assume a typical data acquisition rate of 25 Hz for the marine receivers.

The rms noise, or standard deviation of the measured signal S, can be calculated in the following way. Given the average power spectral density (psd) of the noise in the vicinity of the signal frequency (f₀), the variance of the signal is equal to the total noise power in the measurement bandwidth (Δf), i.e.:

P(N)=var(S)=psd(f₀)Δf.

∴stdev(S)=\sqrt{psd(f₀)Δf.}

The signal is better defined for higher sampling rates. If the signal is defined by n measurements per second, the standard error of the measurement is:

$$∴ sterr ( S ) = \sqrt{\frac{psd ( {f}_{0} ) Δ f}{n}} .$$

To apply this analysis to the noise of seafloor electric field measurements, we need an estimate of the measurement noise of marine electrometers. It has been indicated that state-of-the-art instruments are characterised by white noise for f>0.2 Hz with a power spectral density of ˜10⁻²⁰ V²/m²/Hz, which is close to the theoretical Johnson noise floor. Acquiring the signal for τ=160 s implies a measurement bandwidth of Δf=1/τ=6.25×10⁻³ Hz about the fundamental frequency. Given n=25, the measurement noise of the electric field is then:

$$∴ sterr ( E ) = \sqrt{\frac{6.25 \times {10}^{- 23}}{25}} V \text{/} m = 1.6 pV \text{/} m ,$$

which in most circumstances is much smaller than some other sources of noise.

The electric field noise of geomagnetic origin depends on the level of geomagnetic activity and the ocean depth. Using one theory, at 0.25 Hz surface electric fields will be practically unattenuated at a seafloor depth of 100 m, but attenuated by a factor of 0.3 at the bottom of a 1000 m deep ocean (assuming seafloor resistivity of 10 Ωm). Magnetic fields are substantially more attenuated, by factors of 0.4 and 0.05 for seafloor depths of 100 m and 1000 m respectively. The power spectrum of the geomagnetic field is highly variable, depending on overall geomagnetic activity, and on latitude, local time and other variables. Annually averaged daytime power spectra in the 0.001-0.25 Hz frequency range, measured at a geomagnetic latitude of ˜75° S, show an ˜f⁻⁴ dependence of the power spectral density, with psd at ˜0.25 Hz of 0.003-0.03 (nT)²/Hz. Thus the total noise power within the CSEM detection bandwidth of 6.25×10⁻³ Hz is ˜2-20×10⁻⁵ (nT)² and the corresponding rms noise in B, for 25 samples per second, is ˜1-3×10⁻³ nT=1-3 pT. These represent average values for a high latitude site, at which Pc3-4 activity is stronger than at lower latitudes, but typical maximum values at mid and low latitudes are probably similar to the average values given above.

The geomagnetic power spectra used in the above analysis are in broad agreement with the envelopes of amplitude spectra and with the extrapolated power spectra for Kp=0−3 given by others. At times of particularly intense geomagnetic activity the geomagnetic power spectral density may be up to two orders of magnitude higher, so geomagnetic noise at the surface and in the shallow ocean could in principle be an order of magnitude higher, up to ˜30 pT, for Kp indices of 8-9. These B field fluctuations are attenuated to ˜40% of the surface values in only 100 m of water, decreasing to ˜5% on the seafloor for a water depth of 1000 m (sea water resistivity 0.25 Ωm) with a seafloor apparent resistivity of 10 Ωm.

The noise in E of geomagnetic origin can be calculated from the B noise using the standard magnetotelluric relations at the surface of a half-space. Assuming a subsurface apparent resistivity of 10 Ωm, the magnetotelluric impedance at 0.25 Hz is 4.4×10⁻³Ω. B amplitudes of 1-3 pT at 0.25 Hz correspond to H of 0.8-2.3 μA/m. Multiplying by the impedance yields E amplitudes of 3.5-11 nVm⁻¹, with E field fluctuations up to a maximum of ˜0.1 μVm⁻¹ during major geomagnetic storms. Similar E field fluctuations occur in shallow water, but are attenuated to ˜30% of the surface values on the seafloor for a water depth of 1000 m (sea water resistivity 0.25 Ωm) with a seafloor apparent resistivity of 10 Ωm. Measurements of the power spectral density of E at depths of 100 m and 1000 m in the frequency range of interest have been reported, that data being relatively quiet at the high frequency end with power spectral densities around 0.25 Hz of ˜10⁻¹⁷ V²/m²/Hz and ˜3×10⁻²⁰ V²/m²/Hz at 100 m and 1000 m depths respectively. The corresponding rms noise in E is 0.05 nV/m (100 m) and 0.01 nV/m (1000 m).

Both the maximum amplitude and the fall-off rate with depth of electromagnetic noise from ocean swells is strongly dependent on the wavelength of the swells, and hence on their frequency. The wavelength of gravity waves corresponding to f=0.25 Hz is 25 m. At depths of 100 m or more the magnetic and electric fields produced by even the largest swells of this wavelength are negligible. At lower frequencies, which are also employed in marine CSEM, noise from swells can be significant. For example, at f=0.1 Hz the wavelength is 156 m and wave amplitudes of up to 2.4 m are possible. For such waves, the amplitudes of magnetic field, electric field and magnetic gradient fluctuations at 100 m depth are 0.4 nT, 6 nVm⁻¹ and 16 pTm⁻¹ respectively. At 200 m these amplitudes have reduced to 13 pT, 0.2 nVm⁻¹ and 0.5 pTm⁻¹; and at 300 m they are only 0.3 pT, 5 pVm⁻¹ and 14 fTm⁻¹ respectively.

Although CSEM surveys at frequencies greater than 0.2 Hz should be unaffected by EM noise from simple gravity wave trains with comparable frequencies, interference of opposing wave trains is often observed, particularly over continental shelves. Opposing wave trains resulting, for example, from reflections at coastlines, each of ˜0.125 Hz fundamental frequency, can produce EM fluctuations at ˜0.25 Hz that corrupt the CSEM signal. Furthermore, non-linear interference of opposing wave trains produces pressure fluctuations, at twice the fundamental frequency of the waves, that propagate all the way to the deep ocean floor, resulting in horizontal water motions that generate observable EM effects. These fields have power spectra that are one to three orders of magnitude above the background, centred on 0.1-0.3 Hz, i.e. directly in the commonly employed CSEM band. For example, in 3700 m of water off San Diego a psd peak of ˜10⁻¹⁹ V²/m²/Hz, was observed in this frequency range. Noise power of this order at 0.25 Hz, associated with opposing swells of 100 m wavelength (f=0.125 Hz; C=12.5 ms⁻¹), contributes rms noise of ˜5 pVm⁻¹, which corresponds to rms noise in B (=E/C) of 0.4 pT. Given that this noise level is not exceptional and that the noise power can be up to an order of magnitude higher, rms noise in B due to this effect could be up to ˜1 pT on the deep ocean floor. The corresponding magnetic gradients are ˜80 fTm⁻¹.

The types of noise discussed above can be compared with the CSEM signal at various transmitter-receiver separations to determine the effective range of CSEM exploration. Modelling of CSEM surveys above a 20 Ωm seafloor shows that the radial electric field per unit source dipole moment is ˜10⁻⁴ μVA⁻¹m⁻² at 1 km, ˜10⁻⁶ μVA⁻¹m⁻² at 5 km, decreasing to ˜10⁻⁷ μVA⁻¹m⁻² at 10 km, for CSEM frequencies in the range 0.1-1 Hz. Recent surveys carried out by emgs have used source dipole moments of ˜2×10⁵ Am. The corresponding calculated electric field strengths at 1, 5 and 10 km are therefore ˜20 μVm⁻¹, 0.2 μVm⁻¹, and 20 nVm⁻¹ respectively. Measured fields for the Troll Field are in good agreement with these figures at 1 km and 10 km, with 0.4 μV/m recorded over a reservoir and ˜0.1 μV/m over a reference site without hydrocarbons at 5 km.

These values may be reduced, for a relatively conductive seafloor, by a factor of ˜2, as is observed for the surveys in the North Sea. These surveys show E signal strengths of ˜10 nVm⁻¹ at 10 km, with noise envelopes of ˜2 nVm⁻¹. Corresponding normalised H field signals at 10 km are ˜1-5×10⁻¹¹ m⁻², with a noise envelope of ˜10⁻¹¹m⁻² Multiplying by the source dipole moment and converting H to B gives signal and measured noise levels for B of ˜3-13 pT and ˜3 pT respectively. Horizontal gradients of the magnetic field decrease from a maximum of ˜1 pT m⁻¹ about 1 km from the transmitter to a few fTm⁻¹ at 10 km.

Tables 1-3 below summarise signal and noise levels for CSEM, under various conditions. Table 4 presents a similar analysis for marine magnetotellurics.

TABLE 1
Marine controlled source electromagnetics: signals and noise

| | | | Electro | Induction | | Magnetotelluric | | Oceanographic | |
|---|---|---|---|---|---|---|---|---|---|
| | Signal | | meter | coil | Fluxgate | noise | | noise* | |
| | E | B | noise | noise | noise | E | B | E | B |
| RANGE/DEPTH | (nV/m) | (pT) | (nV/m) | (pT) | (pT) | (nV/m) | (pT) | (nV/m) | (pT) |
| 5 km/D = | 400 | 50-250 | 1.6 × 10⁻³ | 0.003 | 0.1 | 0.05-11 | 1-3 | 0.4 | 30 |
| 100 m | | | | | | | | | |
| 10 km/D = | 20 | 2.5-15 | 1.6 × 10⁻³ | 0.003 | 0.1 | 0.05-11 | 1-3 | 0.4 | 30 |
| 100 m | | | | | | | | | |
| 5 km/D = | 400 | 50-250 | 1.6 × 10⁻³ | 0.003 | 0.1 | 0.01-3 | 0.05-0.15 | 0.005 | 0.4 |
| 1000 m | | | | | | | | | |
| 10 km/D = | 20 | 2.5-15 | 1.6 × 10⁻³ | 0.003 | 0.1 | 0.01-3 | 0.05-0.15 | 0.005 | 0.4 |
| 1000 m | | | | | | | | | |

*Assumed sources of oceanographic noise at 0.25 Hz are opposing swell trains of wavelength 100 m (for 100 m depth) and non-linear interference of these swells, with pressure fluctuations propagating to the ocean floor (for 1000 m depth).

TABLE 2
Seafloor electromagnetic noise from surface waves

| | | f | | | | dB/dx |
|---|---|---|---|---|---|---|
| Type of wave | λ (m) | (Hz) | D (m) | E (nV/m) | B (pT) | (pT/m) |
| Opposing | 100 | 0.25 | 100 | 0.55-1.8 | 44-140 | 3-9 |
| trains/ | | | 200 | 0.002-0.006 | 0.6-1.4 | 0.02-0.05 |
| linear | | | 300 | 6-18 × 10⁻⁶ | 4-14 × 10⁻⁴ | 3-10 × 10⁻⁵ |
| superposition | | | | | | |
| Opposing | 160 | 0.2 | 100 | 6-32 | 400-2000 | 15-75 |
| trains/ | | | 200 | 0.22-1.1 | 14-70 | 0.6-3 |
| linear | | | 300 | 0.006-0.03 | 0.4-2 | 0.02-0.08 |
| superposition | | | 400 | 2-9 × 10⁻⁴ | 0.01-0.05 | 0.0004-0.002 |
| Single | 400 | 0.06 | 100 | 75-900 | 3000-36,000 | 50-570 |
| train | | | 200 | 30-340 | 1100-13,600 | 17-210 |
| | | | 300 | 8-100 | 320-4100 | 5-64 |
| | | | 400 | 1-14 | 45-560 | 0.7-9 |
| | | | 500 | 0.3-3.7 | 12-145 | 0.2-2.3 |
| | | | 600 | 0.07-0.9 | 3-36 | 0.05-0.6 |
| | | | 800 | 0.004-0.05 | 0.16-2 | 0.003-0.03 |
| Opposing | 100 | 0.25 | All | 0.007-0.018 | 0.6-1.4 | 0.04-0.09 |
| trains/ | | | depths | | | |
| nonlinear | | | | | | |
| interaction | | | | | | |

* The first figures given for the fields and magnetic gradient are for A = 1 m, the second figures are for maximum wave height.

TABLE 3
Seafloor CSEM signal/wave-noise ratios

| | λ | f | | | | | |
|---|---|---|---|---|---|---|---|
| Type of wave | (m) | (Hz) | D (m) | S/N (E) | S/N (B) | | S/N (dB/dx) |
| Opposing | 100 | 0.25 | 100 | 11-36 | 0.06-0.3 | (<0.1) | <0.0005 |
| trains/linear | | | 200 | >3300 | 4-25 | (1.8-11) | <0.08 |
| superposition | | | 300 | >10⁴ | >6000 | (>1800) | 8-50 |
| | | | | | | | (2.5-15) |
| Opposing | 160 | 0.2 | 100 | 0.6-3 | 0.006-0.04 | (<0.008) | <0.0001 |
| trains/linear | | | | | | | |
| superposition | | | 200 | 18-90 | 0.2-1.1 | (0.04-0.2) | <0.003 |
| | | | 300 | >670 | 6-40 | (1.3-7.5) | <0.08 |
| | | | 400 | >20,000 | >250 | (>50) | 0.6-3.8 |
| | | | | | | | (0.1-0.8) |
| Single train | 400 | 0.06 | 100 | 0.02-0.3 | 0.001-0.005 | (<0.0004) | <3 × 10⁻⁵ |
| | | | 200 | 0.06-0.7 | 0.002-0.01 | (<0.001) | <9 × 10⁻⁵ |
| | | | 300 | 0.2-2.5 | 0.008-0.05 | (<0.004) | <3 × 10⁻⁴ |
| | | | 400 | 1.4-20 | 0.06-0.3 | (<0.03) | <0.002 |
| | | | 500 | 5-70 | 0.2-1.3 | (<0.1) | <0.008 |
| | | | 600 | 22-290 | 0.8-5 | (0.07-0.4) | <0.03 |
| | | | 800 | >400 | 16-90 | (1.3-7.5) | 0.08-0.5 |
| | | | | | | | (0.1-0.05) |
| Opposing | 100 | 0.25 | All | >1100 | 4-25 | (1.8-11) | <0.04 |
| trains/nonlinear | | | depths | | | | |
| interaction | | | | | | | |

* The first figures given for the S/N(E) values are for A = 1 m, the second figures are for maximum wave height. For S/N(B) and S/N(dB/dx) the first range is for A = 1 m

and minimum to maximum signals at r=10 km; the values in parentheses represent the corresponding range for maximum wave height.

### Magnetotelluric Signal—Geomagnetic Noise

Marine magnetotellurics for exploration purposes employs frequencies from 0.001 Hz to ˜1 Hz. Natural geomagnetic power spectra, as mentioned above, are very variable, but overall show an approximate f⁻² dependence of the power spectral density from 0.0001 to 0.01 Hz, changing to a steeper ˜f⁻⁴ dependence from ˜0.01 Hz to 0.5 Hz.

Although the intrinsic low frequency noise spectrum of induction coils is proportional to 1/f, i.e. the noise power goes as 1/f², this is not a drawback for magnetotelluric work, because the geomagnetic spectrum is also red. The greatest restriction on marine magnetotellurics is the severe attenuation of the fields, particularly the magnetic field, in the deep ocean. At the upper frequency range of the MT method attenuation with depth is so severe that the method can only be used for exploration purposes at depths of less than about 1000 m. At shallow depths wave noise becomes significant, as discussed above in the section on CSEM.

A wide range of geomagnetic power spectra have been reported in the 0.003-3 Hz range, with maximum psd at auroral latitudes and a minimum at lower middle latitudes. At 0.1 Hz the average psd ranges over three orders of magnitude, from 2×10⁻⁵ (nT)²Hz⁻¹ to 2×10⁻² (nT)²Hz⁻¹, whereas the range is 0.4-200 (nT)²Hz⁻¹ for f=0.01 Hz.

Seafloor electric field spectra, at ocean depths of 100 m and 5000 m, have been calculated for periods from two minutes to three hours by applying basic magneto-telluric theory to measured geomagnetic spectra from the Ottawa observatory. For periods of one hour at 100 m depth the E fluctuations range from ˜10 μV/m/√Hz for very quiet times, through ˜30 μV/mA/√Hz for Kp=3, up to a maximum of ˜700 μV/m/√Hz during intense magnetic storms (Kp=8-9). At 5000 m these values decrease to ˜3, 10 and 220 μV/m/√Hz respectively. For periods of five minutes the field fluctuations are weaker (2, 4 and 100 μV/m/√Hz at 100 m) and attenuation with depth is greater (0.1, 0.3 and 10 μV/m/√Hz at 5 km).

Power spectral densities of B and E measured at a depth of 4660 m are about 6000 (nT)²/Hz and 100 μV/Hz respectively at f=0.003 Hz, giving MT signal (or geomagnetic noise, depending on context) of ˜80 nT/√Hz and 10 μV/m/√Hz at this frequency. Signal to noise ratios for MT can be calculated by comparing power spectral densities of the geomagnetic field and instrumental noise within specific frequency bands for which impedance tensors and inverted models are calculated. Data analysis is typically carried on five frequency bins per decade. Table 4 below compares the geomagnetic signal with noise of various origins for the MT method.

TABLE 4
Magnetotellurics: signals and noise

| | | Geomagnetic | | | Fluxgate | E field | | | | |
|---|---|---|---|---|---|---|---|---|---|---|
| | Measurement | signal¹ | | Induction | noise | signal¹ | | E field noise | | |
| Frequency | bandwidth | (nT rms) | | coil noise | (nT | (μV/m rms) | | (μV/m rms) | | Oceanographic |
| (Hz) | (Hz) | Quiet | Active | (nT rms)² | rms)² | Quiet | Active | Land | Marine | noise (nT rms) |
| 1 | 0.2 | 0.0003 | 0.08 | 3 × 10⁻⁵ | 0.001 | 0.002 | 0.6 | 0.001 | 4.5 × 10⁻⁵ | negligible |
| 0.1 | 0.02 | 0.01 | 0.05 | 7 × 10⁻⁵ | 0.003 | 0.02 | 0.11 | 0.004 | 4.5 × 10⁻⁵ | 0.3 (100 m) 0.001 |
| | | | | | | | | | | (great depth) |
| 0.01 | 0.002 | 0.04 | 4.5 | 14 × 10⁻⁵ | 0.01 | 0.03 | 3.2 | 0.004 | 1.4 × 10⁻⁴ | negligible? |
| 0.001 | 0.0002 | 0.1 | 15 | 0.004 | 0.03 | 0.02 | 3.4 | 0.014 | 4.5 × 10⁻⁴ | negligible? |
| 0.0001 | 0.00002 | 0.45 | 50 | 0.04 | 0.1 | 0.03 | 3.5 | 0.045 | 1.4 × 10⁻³ | 0.5 (internal waves) |
| | | | | | | | | | | 5 (tides)³ |

¹MT fields are for land and near surface marine. In the deep ocean the higher frequency fields are considerably attenuated.
²For vector sensors, such as induction coils and fluxgates, the instrumental noise is dominated by vibration and tilting. Integration with sensitive tiltmeters is essential to obtain noise levels close to the instrumental noise levels given here.
³Tidal effects, although strong, are regular and predictable, allowing correction.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method for noise compensation in controlled source electromagnetics (CSEM), the method comprising:
measuring time—varying magnetic gradients of a marine environment subjected to CSEM;
from the measured magnetic gradients, determining oceanographic electric and magnetic field noise; and
compensating CSEM measurements of electric and magnetic fields for noise by using the determined oceanographic electric and magnetic noise.

2. The method of claim 1 wherein measuring time-varying magnetic gradients comprises measurement of at least one of a magnetic gradient tensor and total field gradients.

3. The method of claim 1 wherein measuring time-varying magnetic gradients comprises measurements of fluctuations in the horizontal gradient of the total field in the direction of propagation, as determined by two or more toal field gradiometers with horizontal axes along different directions.

4. The method of claim 1 wherein the compensating comprises suppression of wave-induced noise by design of a filter based on identified gradient fluctuations within a specified frequency band.

5. The method of claim 4 wherein the specified frequency band is substantially 0.05-0.2 Hz for oceanographic noise due to wave motions.

6. The method of claim 1 wherein the compensating comprises, in cases where well-defined gradient fluctuations are measured, directly calculating corresponding wave-induced magnetic and electric fields and removing them from the CSEM measurements.

7. The method of claim 1, wherein a sensor measuring the time-varying magnetic gradients is housed within the marine environment by a substantially spherical cavity, and wherein magnetic field is measured directly and electric field measurements are amplitude adjusted to allow for the effect that electric field within the cavity is uniform, parallel to the unperturbed applied field and larger by 50%.

8. The method of claim 7 wherein measurements of the time varying magnetic gradients are adjusted to allow for the effect that within the cavity the time-vary ing symmetric magnetic gradient tensor due to wave motions is uniform with the only nonzero elements being off-diagonal elements that are each equal to one half of the nonzero element of the asymmetric magnetic gradient tensor due to electric current flow in the external unperturbed seawater.

9. The method of claim 1 further comprising rotating a magnetometer about an axis and measuring the field component at a plurality of different orientations during the rotation, in order to improve instrumental sensitivity.

10. A system for noise compensation in controlled source electromagnetics (CSEM), the system comprising:
at least one magnetic gradiometer for measuring magnetic gradients of a marine environment subjected to CSEM;
a data processing means which is arranged to, from the measured magnetic gradients, determine oceanographic electric and magnetic noise, and which is arranged to compensate CSEM measurements for noise by using the determined oceanographic electric and magnetic noise.

11. A computer program product comprising computer program code means to make a computer execute a procedure for noise compensation in controlled source electromagnetics (CSEM), the computer program product comprising:
computer program code means for measuring magnetic gradients of a marine environment subjected to CSEM;
computer program code means for determining oceanographic electric and magnetic noise from the measured magnetic gradients; and
computer program code means for compensating CSEM measurements for noise by using the determined oceanographic electric and magnetic noise.

12. The computer program product of claim 11 wherein the computer program code means for measuring time-varying magnetic gradients comprises computer program code means for measurement of at least one of a magnetic gradient tensor and total field gradients.

13. The computer program product of claim 11 wherein the computer program code means for measuring time-varying magnetic gradients comprises computer program code means for measurements of fluctuations in the horizontal gradient of the total field in the direction of propagation.

14. The computer program product of claim 11 wherein the computer program code means for compensating CSEM measurements comprises computer program code means for suppression of wave-induced noise by design of a filter based on identified gradient fluctuations within a specified frequency band.

15. The computer program product of claim 14 wherein the specified frequency band is substantially 0.05-0.2 Hz for oceanographic noise due to ocean wave motions.

16. The computer program product of claim 11 wherein the computer program code means for compensating CSEM measurements comprises computer program code means for, in cases where well-defined gradient fluctuations are measured, directly calculating corresponding wave-induced magnetic and electric fields and removing them from the CSEM measurements.

17. The computer program product of claim 11, wherein a sensor measuring the time-varying magnetic gradients is housed within the marine environment by a substantially spherical cavity, and further comprising computer program code means for measured magnetic field directly and for amplitude adjusting electric field measurements to allow for the effect that electric field within the cavity is uniform, parallel to the unperturbed applied field and larger by 50%.

18. The computer program product of claim 17 further comprising computer program code means for adjusting measurements of the time varying magnetic gradients to allow for the effect that within the cavity the time-varying symmetric magnetic gradient tensor due to wave motions is uniform with the only nonzero elements being off-diagonal elements that are each equal to one half of the nonzero element of the asymmetric magnetic gradient tensor due to electric current flow in the external unperturbed seawater.

19. The computer program product of claim 11 further comprising computer program code means for rotating a magnetometer about an axis and measuring the field component at a plurality of different orientations during the rotation, in order to improve instrumental sensitivity.
